(19) United States
(12) Patent Application Publication
(10) Pub. No.: US 2016/0093448 A1
(43) Pub. Date: Mar. 31, 2016

(54) PHOTOCATALYST MATERIAL AND PHOTOCATALYST DEVICE

(71) Applicants: NATIONAL UNIVERSITY CORPORATION KYOTO INSTITUTE OF TECHNOLOGY, Kyoto-shi (JP); SAKAI CHEMICAL INDUSTRY CO., LTD., Osaka (JP)

(72) Inventors: Saki Sonoda, Kyoto-shi (JP); Osamu Kawasaki, Kyoto-shi (JP); Junichi Kato, Kyoto-shi (JP); Mutsuo Takenaga, Kyoto-shi (JP)

(73) Assignees: SAKAI CHEMICAL INDUSTRY CO., LTD., Osaka (JP); NATIONAL UNIVERSITY CORPORATION KYOTO INSTITUTE OF TECHNOLOGY, Kyoto-shi (JP)

(21) Appl. No.: 14/824,658

(22) Filed: Aug. 12, 2015

Related U.S. Application Data
(62) Division of application No. 13/806,950, filed on Dec. 26, 2012, now abandoned.

(30) Foreign Application Priority Data
Jun. 25, 2010 (JP) 2010-145138

(51) Int. Cl. H01G 9/20; C25B 1/00; C25B 1/04; C25B 11/04

(52) U.S. Cl. CPC H01G 9/205; C25B 11/0478; C25B 1/003; C25B 1/04

(57) ABSTRACT

A photocatalyst material and a photocatalyst device capable of generating hydrogen from water by radiation of sunlight at high efficiency. The photocatalyst material according to the present invention includes a nitride-based compound semiconductor obtained by replacement of part of Ga and/or Al by a 3d-transition metal. The nitride-based compound semiconductor has one or more impurity bands. A light absorption coefficient of the nitride-based compound semiconductor is 1,000 cm⁻¹ or more in an entire wavelength region of 1,500 nm or less and 300 nm or more. Further, the photocatalyst material satisfies the following conditions: the energy level of the bottom of the conduction band is more negative than the redox potential of H⁺/H₂; the energy level of the top of the valence band is more positive than the redox potential of O₂/H₂O; and there is no or little degradation of a material even when the material is irradiated with light underwater.

### CROSS-REFERENCE TO RELATED APPLICATIONS

This is a divisional application of U.S. patent application Ser. No. 13/806,950, filed on Dec. 26, 2012, which is a 371 of International Application No. PCT/JP2011/064534, filed on Jun. 24, 2011, which claims the benefit of priority from the prior Japanese Patent Application No. 2010-145138, filed on Jun. 25, 2010, the entire contents of which are incorporated herein by reference.

### TECHNICAL FIELD

The present invention relates to a photocatalyst material and a photocatalyst device, and more specifically, to a photocatalyst material having a multiband structure capable of performing a photocatalytic operation in infrared, visible, and ultraviolet ray regions and a photocatalyst device using the photocatalyst material.

### BACKGROUND ART

In recent years, against the backdrop of a global environmental problem such as a CO₂ emission problem caused by the use of fossil fuel, and an energy cost problem such as a rise in crude oil price, there has been an increasing expectation toward creation of clean new energy, as typified by a solar cell, a fuel cell and an energy device which use hydrogen as fuel, and the like. Instead of a method of obtaining hydrogen, which is fuel for the fuel cell, the energy device, and the like, from fossil fuel, a method of producing hydrogen from water using a water decomposition photocatalyst has the high potential to contribute to solve the environmental and energy problems, and thus, there is a high expectation toward this method.

A photocatalyst is capable of detoxifying harmful substances through decomposition thereof and generating hydrogen and oxygen through decomposition of water, utilizing the fact that holes and electrons excited in the catalyst by light have very high oxidizing power and reducing power, respectively. A semiconductor photocatalyst has an energy band structure in which the conduction band and the valence band are separated by the forbidden band. When a photocatalyst is irradiated with light having energy equal to or higher than a band gap, electrons in the valence band are excited to the conduction band, while holes are generated in the valence band. The electrons excited to the conduction band have higher reducing power than that when the electrons are present in the valence band, and the holes have higher oxidizing power.

In order to decompose water, it is necessary that the energy level of the bottom of the conduction band be more negative than the redox potential of H⁺/H₂, and the energy level of the top of the valence band be more positive than the redox potential of O₂/H₂O. That is, it is necessary that the band gap be 1.23 eV or more if it is assumed that there is no overvoltage of reaction at all. In order to allow a photocatalyst device to function, it is desired that the band gap be generally 1.8 eV or more.

A typical example of a semiconductor photocatalyst which has been studied so far is titanium oxide TiO₂. The production of hydrogen directly from water through a semiconductor photocatalyst originates in the study of Honda and Fujishima in 1970s (Non Patent Document 1). This document shows that hydrogen can be generated from photodecomposing water directly by irradiating a TiO₂ electrode of a photochemical cell formed of a TiO₂ photoelectrode and a Pt electrode with light. Sunlight reaching the surface of the earth has maximum radiation intensity in the vicinity of 500 nm of visible rays. However, TiO₂ has a band gap of 3.2 eV, which is much larger than 1.8 eV. Thus, there is a problem in that TiO₂ is active only in an ultraviolet ray region with a wavelength of 390 nm or less and has poor use efficiency of sunlight and low hydrogen generation efficiency although TiO₂ has a high photocatalytic function.

On the other hand, in order to absorb a visible ray region as well as an ultraviolet ray region of sunlight with high efficiency, a non-oxide semiconductor having a smaller band gap has been sought for. Typical examples thereof include metal chalcogenide such as CdS and CdSe. However, there is a problem in that the material itself is molten by oxidation due to holes generated in the valence band when the material is irradiated with light and does not function stably. Organic materials have also been sought for, but have not been put into practical use as well due to the serious stability problem of a material.

In titanium oxide TiO₂, there has been proposed a method of shifting a light absorption wavelength to a long wavelength side in an active oxynitride. For example, there has been proposed a method of obtaining high activity by radiation of visible rays by placing a metal oxide (tungsten oxide) WO₃ having an acid site other than titanium oxide on the surface of titanium oxide TiO₂. However, although relatively higher activity is exhibited in a range of 400 to 500 nm, there is a problem in that a light absorption coefficient is still small on a longer wavelength side (Patent Document 1). Another conventional example is Ti—O—N. Ti—O—N exhibits higher activity in a range of 400 to 480 nm than TiO₂, but its activity is very low at 500 nm or more, which is the center wavelength of visible rays (Patent Document 2). Further, a Ti—Cr—O—N film containing Cr and N forms a new level in a band gap and has a large light absorption coefficient in a long wavelength region of 400 to 500 nm, compared with TiO₂, Ti—O—N, and Ti—O—S(Patent Document 3). However, in these conventional examples, light absorption is not large at a wavelength in the entire range of 360 to 830 nm, which is the visible ray region, or more. Thus, the problem of low use efficiency of sunlight has not been solved yet.

Besides titanium oxide TiO₂, there has been proposed a method of using a nitride semiconductor. A GaN photocatalyst and a GaN photocatalyst mixed with InN have photocatalytic activity and have also been studied. However, the GaN photocatalyst exhibits photocatalytic activity only in the ultraviolet ray region, and the GaN photocatalyst mixed with InN exhibits photocatalytic activity in a region closer to the a visible ray. Light absorption only in the vicinity of a wavelength corresponding to a band gap increases. Thus, in order to enhance photocatalytic activity in a broader wavelength region, a complicated structure of a tandem structure, which is a multilayer structure, needs to be adopted (Patent Document 4).

Further, as a nitride semiconductor electrode, there has been proposed a gas generating device using a compound formed of at least one III-group element selected from the group consisting of indium (In), gallium (Ga), and aluminum (Al), and nitrogen (N) (Patent Document 5). The nitride semiconductor of Patent Document 5 is a compound represented by a general formula AlₓIn₂Ga_{1-x-y}N (wherein 0≦X≦1, 0≦Y≦1, and X+Y≦1). The band gap of the nitride semiconductor can be variably controlled from 1.9 eV to 6.2 eV depending upon the composition, and the nitride semiconductor can absorb light having a wavelength of ultraviolet rays to a wavelength of 650 nm depending on the band gap. However, also in this case, light absorption only in the vicinity of a wavelength corresponding to a band gap merely increases, and sunlight in a broader wavelength range cannot be used effectively.

In addition, a water decomposition catalyst which uses p-type GaN or in which a promoter such as RuO₂ is supported in p-type GaN has been proposed (Patent Document 6). However, an active wavelength is 400 nm or less, and no catalyst has large absorption in an entire region of 360 to 830 nm, which is the visible ray region exceeding 40% of sunlight energy. Thus, the problem of low energy use efficiency of sunlight has not been solved yet. Further, a light absorption coefficient in a wavelength band of 300 to 1,500 nm is a minimum value of about 600 to 700 cm⁻¹ in the case of GaN and about 200 to 300 cm⁻¹ in the case of AlN. Thus, only a small value has been achieved (for example, Non Patent Document 2).

### CITATION LIST

### Patent Documents

Patent Document 1: JP2002-126517A
Patent Document 2: JP2002-095976A
Patent Document 3: JP2001-205104A
Patent Document 4: WO2005/089942A1
Patent Document 5: JP2003-024764A
Patent Document 6: JP2007-125496A

### Non Patent Documents

Non Patent Document 1: K. Honda, A. Fujishima, Nature, 238, 37 (1972)
Non Patent Document 2: Appl. Phys. Lett., 81, 5159 (2002)

### SUMMARY OF INVENTION

### Technical Problem

As described above, in order to produce hydrogen directly from water through a semiconductor photocatalyst by radiation of sunlight at high efficiency, a material satisfying the following conditions is required: (1) light absorption efficiency is high in a broad region including a visible ray region and an infrared ray region as well as an ultraviolet ray region of sunlight; (2) for production of hydrogen, the energy level of the bottom of the conduction band is more negative than the redox potential of H⁺/H₂, and for production of oxygen, the energy level of the top of the valence band is more positive than the redox potential of O₂/H₂O; and (3) there is no or little degradation of a material even when the material is irradiated with light underwater. Various attempts have been made so as to satisfy the above-mentioned three conditions, but as described in the Background Art, a practical technology has not been found yet.

The present invention has been made in view of the above-mentioned circumstances, and it is an object of the present invention to provide a photocatalyst material satisfying the conditions: (1) light is absorbed almost in an entire region of infrared rays, visible rays, and ultraviolet rays of sunlight; (2) the energy level of the bottom of the conduction band is more negative than the redox potential of H⁺/H₂, and the energy level of the top of the valence band is more positive than the redox potential of O₂/H₂O; and (3) there is no or little degradation of a material even when the material is irradiated with light underwater, and also provide a photocatalyst device using the photocatalyst material.

### Solution to Problem

In order to solve the above-mentioned problems, the inventors of the present invention conducted various studies, and consequently have found that a nitride-based compound semiconductor having an impurity band has high absorption efficiency almost in an entire region of ultraviolet rays, visible rays, and infrared rays of sunlight and thus has high efficiency of charge carrier excitation by radiation of sunlight, there is little degradation of the material during use, and the energy level of the bottom of the conduction band is more negative than the redox potential of H⁺/H₂ and the energy level of the top of the valence band is more positive than the redox potential of O₂/H₂O, thereby achieving the present invention.

That is, according to the present invention, there is provided a photocatalyst material, comprising a nitride-based compound semiconductor including a compound represented by a general formula Al_{1-y}Ga_{y}N (0≦y≦1), part of Al and/or Ga in the compound being replaced by at least one kind of 3d-transition metals, wherein the nitride-based compound semiconductor has one or more impurity bands between a valence band and a conduction band; and a light absorption coefficient of the nitride-based compound semiconductor has a value of 1,000 cm⁻¹ or more in an entire wavelength region of 1,500 nm or less and 300 nm or more.

In the photocatalyst material of the present invention, it is preferred that the at least one kind of 3d-transition metals be at least one kind selected from the group consisting of Sc, Ti, V, Cr, Mn, Fe, Co, Ni, and Cu.

Further, in the photocatalyst material of the present invention, when a replacement amount of Ga with respect to Al is y and a replacement amount of a 3d-transition metal T is x, it is preferred that the nitride-based compound semiconductor be represented by a general formula (Al_{1-y}Ga_{y})₁₋ₓT, wherein 0≦y≦1, and 0.02≦x≦0.3.

Further, in the photocatalyst material of the present invention, it is preferred that a layer of the nitride-based compound semiconductor be doped with an acceptor dopant and/or a donor dopant.

Further, in the photocatalyst material of the present invention, it is preferred that a first semiconductor layer formed of the nitride-based compound semiconductor have a second semiconductor layer laminated thereon, the second semiconductor layer being formed of an n-GaN layer or a p-GaN layer.

Further, in the photocatalyst material of the present invention, it is preferred that the first semiconductor layer and the second semiconductor layer form a pn junction.

Further, in the photocatalyst material of the present invention, it is preferred that the first semiconductor layer formed of the nitride-based compound semiconductor include two layers forming a pn junction.

Further, according to the present invention, there is provided a photocatalyst device using a photocatalyst material, the photocatalyst material including a nitride-based compound semiconductor having a compound represented by a general formula Al_{1-y}Ga_{y}N (0≦y≦1), part of Al and/or Ga in the compound being replaced by at least one kind of 3d-transition metals, wherein the nitride-based compound semiconductor has one or more impurity bands between a valence band and a conduction band; and a light absorption coefficient of the nitride-based compound semiconductor has a value of 1,000 cm⁻¹ or more in an entire wavelength region of 1,500 nm or less and 300 nm or more.

In the photocatalyst device of the present invention, it is preferred that the photocatalyst device include a cathode and an anode connected to each other electrically, and that the photocatalyst material be used for the cathode or the anode.

Further, in the photocatalyst device of the present invention, it is preferred that a first semiconductor layer formed of the nitride-based compound semiconductor have a second semiconductor layer laminated thereon, the second semiconductor layer being formed of an n-GaN layer or a p-GaN layer.

Further, in the photocatalyst device of the present invention, it is preferred that the first semiconductor layer and the second semiconductor layer form a pn junction.

Further, in the photocatalyst device of the present invention, it is preferred that the first semiconductor layer formed of the nitride-based compound semiconductor include two layers forming a pn junction.

### Advantageous Effects of Invention

The photocatalyst material of the present invention has an intermediate band formed of an impurity band between band gaps, and thus, the photocatalyst material can absorb light in the visible ray region and the infrared ray region, which cannot be absorbed by a parent material before replacement of a 3d-transition metal, as well as in an ultraviolet ray region. That is, the photocatalyst material has a light absorption coefficient of 1,000 cm⁻¹ or more in an entire wavelength region of 1,500 nm or less and 300 nm or more. Conventionally, in this wavelength region, a photocatalyst material has a minimum value of a light absorption coefficient of about 600 to 700 cm⁻¹ in GaN and 200 to 300 cm⁻¹ similarly in AlN, whereas the photocatalyst material of the present invention has a very large light absorption coefficient. Thus, it is possible to use sunlight having a wavelength which cannot be used in a parent material before replacement of a 3d-transition metal, and thus, photocatalyst efficiency and hydrogen generation efficiency can be enhanced. Further, the photocatalyst material of the present invention has a large light absorption coefficient with respect to light in a broad wavelength band, and thus, even when a wavelength distribution of sunlight on the earth changes due to a change in weather such as fair, cloudy, and rainy days, a photocatalytic effect with little change can be achieved.

Further, the photocatalyst material of the present invention is produced at high temperatures of from 300° C. to 1,000° C., and thus, is excellent in stability with respect to heat. The photocatalyst material of the present invention is also stable with respect to water, and thus, can achieve excellent stability when used in a photocatalyst device.

Further, the photocatalyst material of the present invention does not use elements having strong toxicity, such as As and Cd, as in GaAS-based and CdTe-based compound semiconductors, and thus, is excellent environmentally. Further, the photocatalyst material of the present invention does not use a rare metal such as In, and thus, can be produced at lower cost, which enables a photocatalyst device to be provided at lower cost.

Further, the photocatalyst material of the present invention can be produced also by a film formation method such as sputtering, instead of an MBE method. Thus, elements with large areas can be mass-produced easily, which enables a photocatalyst device to be provided at lower cost. Further, a material can be designed easily in accordance with use environment such as a sunshine condition, by selection of a parent material, selection of the kind of 3d-transition metals, and a replacement amount thereof.

Light to be radiated to the photocatalyst material of the present invention is not limited to sunlight, and artificial light such as fluorescent light can also be used. Further, the application of the photocatalyst material of the present invention is not limited to a photocatalyst device for generating hydrogen, in which hydrogen is obtained from water (aqueous solution), and the photocatalyst material of the present invention can also be used as a photocatalyst device for decomposing a harmful substance, in which a harmful substance is decomposed and detoxified by a redox reaction of electrons and holes.

### BRIEF DESCRIPTION OF DRAWINGS

FIG. 1 is a schematic diagram showing a relationship between a band level of nitride semiconductor and a redox potential.

FIG. 2 is a schematic view illustrating a band structure of a photocatalyst material to be used in a photocatalyst device according to a first embodiment of the present invention.

FIG. 3 is a schematic view illustrating an example of a structure of a photocatalyst device using the photocatalyst material of FIG. 2.

FIG. 4 is a schematic view illustrating a band structure of a photocatalyst material to be used in photocatalyst devices according to second and third embodiments of the present invention.

FIG. 5 is a schematic view illustrating an example of a structure of a photocatalyst device using the photocatalyst material of FIG. 4.

FIG. 6 is a schematic view illustrating another example of the structure of the photocatalyst device using the photocatalyst material of FIG. 4.

FIG. 7 is a schematic view illustrating a band structure of a photocatalyst material to be used in photocatalyst devices according to fourth and fifth embodiments of the present invention.

FIG. 8 is a schematic view illustrating an example of a structure of a photocatalyst device using the photocatalyst material of FIG. 7.

FIG. 9 is a schematic view illustrating another example of the structure of the photocatalyst device using the photocatalyst material of FIG. 7.

FIG. 10 is a schematic view illustrating an example of a structure of a photocatalyst device using a photocatalyst material to be used in a photocatalyst device according to a sixth embodiment of the present invention.

FIG. 11 is a light absorption spectrum of a photoelectric conversion material according to Example 1 of the present invention.

FIG. 12 is a light absorption spectrum of a photoelectric conversion material according to Example 4 of the present invention.

FIG. 13 is a light absorption spectrum of a sample in which a 3d-transition metal is V and x is 0.056 according to Example 5 of the present invention.

FIG. 14 is a light absorption spectrum of a sample in which a 3d-transition metal is Cr and x is 0.088 according to Example 5 of the present invention.

FIG. 15 is a light absorption spectra of samples in which a 3d-transition metal is Co and x is 0.052 and 0.128 according to Example 5 of the present invention.

FIG. 16 is a light absorption spectrum of a sample in which a 3d-transition metal is Mn and x is 0.2 according to Example 5 of the present invention.

FIG. 17 is light absorption spectra of GaVN, AlGaVN, and AlVN in which a 3d-transition metal is V and which are substituted by 5% with V according to Example 6 of the present invention.

FIG. 18 is light absorption spectra of GaCrN, AlGaCrN, and AlCrN in which a 3d-transition metal is Cr and which are substituted by 9% with Cr according to Example 6 of the present invention.

FIG. 19 is light absorption spectra of GaCoN and AlCoN in which a 3d-transition metal is Co according to Example 6 of the present invention.

FIG. 20 is Light absorption spectra of AlMnN (Mn: 11%) and AlGaMnN (Mn: 20%) in which a 3d-transition metal is Mn according to Example 6 of the present invention.

FIG. 21 is light absorption spectra of AlNiN and AlGaNiN in which a 3d-transition metal is Ni according to Example 6 of the present invention.

FIG. 22 is a schematic view illustrating a band structure of a photocatalyst material to be used in a photocatalyst device according to a seventh embodiment of the present invention.

FIG. 23 is a schematic view illustrating an example of a structure of a photocatalyst device using the photocatalyst material of FIG. 22.

FIG. 24 is a schematic view illustrating a band structure of a photocatalyst material to be used in photocatalyst devices according to eighth and ninth embodiments of the present invention.

FIG. 25 is a schematic view illustrating an example of a structure of a photocatalyst device using the photocatalyst material of FIG. 24.

FIG. 26 is a schematic view illustrating another example of the structure of the photocatalyst device using the photocatalyst material of FIG. 24.

FIG. 27 is a schematic view illustrating a structure of a photocatalyst device using a photocatalyst material AlNiN according to a tenth embodiment of the present invention.

FIG. 28 is a schematic view illustrating a structure of a photocatalyst device using a photocatalyst material AlGaNiN according to an eleventh embodiment of the present invention.

### DESCRIPTION OF EMBODIMENTS

Embodiments of the present invention are described hereinafter in detail with reference to the drawings.

A photocatalyst material of the present invention is a material containing a nitride-based compound semiconductor including a compound semiconductor represented by a general formula Al_{1-y}Ga_{y}N (0≦y≦1), part of Al and/or Ga of the compound semiconductor being replaced by at least one kind of a 3d-transition metal (represented by T).

The compound semiconductor represented by the general formula Al_{1-y}Ga_{y}N (0≦y≦1) includes GaN-based, GaAlN-based, and AlN-based compound semiconductors.

Of the GaN-based compound semiconductors, GaN is a semiconductor having a band gap of 3.4 eV (corresponding to a light wavelength of 365 nm), which absorbs ultraviolet rays but does not absorb light having a wavelength of visible rays or more. Therefore, even when the GaN is irradiated with light having a wavelength of visible rays or more, there is no transition of electrons from the valence band to the conduction band. In contrast, a compound semiconductor (hereinafter abbreviated as “GaTN”) represented by a general formula Ga₁₋ₓTₓN (0.02≦x≦0.3) obtained by replacement of part of Ga by the 3d-transition metal T has an impurity band of the 3d-transition metal T replacing part of Ga in a band gap while keeping the band structure of GaN. In this case, the 3d-transition metal is not limited to one kind, and a plurality of 3d-transition metals can also be used in such a manner that a total amount of replacement by a plurality of 3d-transition metals becomes x. In the present invention, replacement of Ga and/or Al by a 3d-transition metal means that Ga or Al can be replaced by a 3d-transition metal in a range in which the 3d-transition metal replacing Ga and/or Al can form an impurity band.

Further, of the AlN-based compound semiconductors, AlN is a semiconductor having a band gap of 6.2 eV (200 nm), which absorbs ultraviolet rays but does not absorb light having a wavelength of visible rays or more. Therefore, even when the AlN is irradiated with light having a wavelength of visible rays or more, there is no transition of electrons from the valence band to the conduction band. In contrast, a compound semiconductor (hereinafter abbreviated as “AlTN”) represented by a general formula Al₁₋ₓTₓN (0.02≦x≦0.3) obtained by replacement of part of Al by the 3d-transition metal T has an impurity band of the 3d-transition metal T replacing part of Al in a band gap while keeping the band structure of AlN. In this case, the 3d-transition metal is not limited to one kind, and a plurality of 3d-transition metals can be used in such a manner that a total amount of replacement by a plurality of 3d-transition metals becomes x.

Further, of the GaAlN-based compound semiconductors, GaAlN is a semiconductor having a band gap of 3.4 to 6.2 eV (200 to 365 nm), which absorbs ultraviolet rays but does not absorb light having a wavelength of visible rays or more. Therefore, even when the GaAlN is irradiated with light having a wavelength of visible rays or more, there is no transition of electrons from the valence band to the conduction band. In contrast, a compound semiconductor (hereinafter abbreviated as “GaAlTN”) represented by a general formula (GaAl)₁₋ₓTₓN (0.02≦x≦0.3) obtained by replacement of part of Ga and Al by the 3d-transition metal T has an impurity band of the 3d-transition metal T replacing part of Ga and Al in a band gap while keeping the band structure of GaAlN. Similarly, the 3d-transition metal T is not limited to one kind, and a plurality of 3d-transition metals can be used in such a manner that a total amount of replacement by a plurality of 3d-transition metals becomes x.

For the 3d-transition metal, one or more kinds of metals selected from the group consisting of Sc, Ti, V, Cr, Mn, Fe, Co, Ni, and Cu are used. V, Cr, Mn, and Co are more preferred. The band chiefly composed of a 3d-orbit of the transition metal can form the impurity band in the band gap of GaN without being superimposed with the valence band and the conduction band. Further, since the impurity bands corresponding to two or more kinds of 3d-transition metals can be formed, two or more impurity bands can be formed. Here, Sc, Ti, V, Cr, Mn, Fe, Co, Ni, and Cu have electron configuration of 3d²4s², 3d²4s², 3d³4s², 3d⁵4s², 3d⁵4s², 3d⁶4s², 3d⁷4s², 3d⁸4s², and 3d¹⁰4s, respectively. The 3d-transition metal has two or less 4s-electrons in an outermost shell which form crystal bonds. Meanwhile, since one electron is short in replacement of trivalent Ga and/or Al by the 3d-transition metal, one 3d-electron is used. This brings the impurity band capable of accommodating five d-electrons into an unoccupied state. When the impurity band is in the unoccupied state, light can be absorbed in two or more stages through the impurity band, other than by direct transition from the valence band to the conduction band of GaN, GaAlN, or AlN, so that high conversion efficiency can be expected. In particular, V, Cr, Mn, and Co, especially, Mn is preferred for its high probability of carrier transition by radiation of light because of good balance between the unoccupied state of the impurity band and the ground state of the electrons as described above.

For example, the GaN-based compound semiconductor containing Mn can be represented by a general formula Ga₁₋ₓMnₓN, wherein 0.02≦x≦0.3. The range of x is preferably 0.05≦x≦0.25, and more preferably 0.05≦x≦0.20. When x is smaller than 0.02, an impurity band sufficient for efficiently performing carrier transition by radiation of light is not generated. When x is larger than 0.3, the valence band and the impurity band are superimposed and/or the conduction band and the impurity band are superimposed, and thus the impurity band is not formed therebetween. In the present invention, the fact that an impurity band sufficient for efficiently performing carrier transition by radiation of light is not formed means that the light absorption coefficient in the wavelength region of 300 to 1,500 nm is smaller than 1,000 cm⁻¹. Further, when x is larger than 0.3, an impurity band with sufficient density is not formed, and thus, the light absorption coefficient in the wavelength region of 300 to 1,500 nm becomes smaller than 1,000 cm⁻¹.

Further, another photocatalyst material of the present invention is formed of a GaN-based, GaAlN-based, or AlN-based compound semiconductor obtained by replacement of Ga and/or Al by at least one kind of 3d-transition metals and by being doped with an acceptor dopant and/or a donor dopant. The light absorption coefficient at least in the wavelength region of 300 to 1,500 nm is 1,000 cm⁻¹ or more. Here, the 3d-transition metals are metals having atomic numbers of 21 to 29, which are Sc, Ti, V, Cr, Mn, Fe, Co, Ni, and Cu. Preferably, the 3d-transition metals are V, Cr, Co, and Mn, and more preferably, Mn.

The acceptor dopant usually receives electrons from a parent material (GaN, GaAlN, or AlN) to generate holes in the valence band, but, in the present invention, electrons are taken out of the impurity band derived from the 3d-orbit, to thereby form the unoccupied state in the impurity band. It is therefore possible to enhance the photoelectric conversion efficiency. Examples of this acceptor dopant include Mg, Ca, and C, and Mg is particularly preferred. Although the GaN-based, GaAlN-based, or AlN-based compound semiconductor to be doped with Mg is not particularly limited, a GaN-based, GaAlN-based, or AlN-based compound semiconductor containing Mn is preferred. This is because a satisfactory crystal can be obtained in the combination of Mn with Mg. For example, a material obtained by doping a GaN-based compound semiconductor containing Mn with Mg can be represented by a general formula Ga_{1-x-z}MnₓMg_{z}N (0.02≦x≦0.3, 0<z≦0.125), (GaAl)_{1-x-z}MnₓMg_{z}N (0.02≦x≦0.3, 0<z≦0.125), or Al_{1-x-z}MnₓMg_{z}N (0.02≦x≦0.3, 0<z≦0.125). The range of x is more preferably 0.05≦x≦0.3. Here, it is not preferred that z be larger than 0.125 because it becomes difficult for Mn to form a solid solution.

The donor dopant usually gives electrons to the parent material (GaN, GaAlN, or AlN) to generate electrons as carriers in the conduction band, but, in the present invention, the electrons released from the donor dopant enter into the unoccupied portion of the impurity band. It is therefore possible to enhance the photoelectric conversion efficiency. Examples of this donor dopant include H (hydrogen atoms), Si, and O (oxygen atoms), and H is particularly preferred. For example, a material obtained by doping a GaN-based compound semiconductor containing Mn with H can be represented by a general formula Ga₁₋ₓMnₓN:H_{y} (0.02≦x≦0.3, 0<y<x), (GaAl)₁₋ₓMnₓN:H_{y} (0.02≦x≦0.3, 0<y<x), or Al₁₋ₓMnₓN:H_{y} (0.02≦x≦0.3, 0<y<x). This is because, when y is equal to or more than x, the impurity band is fully occupied, and absorption in two or more stages does not occur. The range of x is more preferably 0.05≦x≦0.3.

These acceptor dopant and donor dopant may coexist in Ga₁₋ₓMnₓN, (GaAl)₁₋ₓTₓN, or Al₁₋ₓTₓN. For example, in the case of Ga₁₋ₓMnₓN, a general formula can be represented by Ga_{1-x-z}MnₓMgₓN:H_{y} (0.02≦x≦0.3, 0<z≦0.125, 0<y-z<x when y>z, and 0<y≦z when y≦z), (GaAl)_{1-x-z}MnₓMgₓN:H_{y} (0.02≦x≦0.3, 0<z≦0.125, 0<y-z<x when y>z, and 0<y≦z when y≦z), or Al_{1-x-z}MnₓMgₓN:H_{y} (0.02≦x≦0.3, 0<z≦0.125, 0<y-z<x when y>z, and 0<y≦z when y≦z). This is because, in the case where a concentration y of hydrogen, which is a donor, is higher than a concentration z of Mg, which is an acceptor, namely, in the case of y>z, (y-z) represents the number of effective donors, and when (y-z) is larger than x, the impurity band is fully occupied, and absorption in two or more stages does not occur.

The nitride-based compound semiconductor of the present invention, such as GaTN, GaAlTN, or AlTN, can absorb light in two or more stages through the impurity band, and has a peak or a tail of light absorption other than direct transition from the valence band to the conduction band of GaN, GaAlN, or AlN as a parent material. At the peak or the tail, the light absorption coefficient at least in the wavelength region of 1,500 nm or less and 300 nm or more is 1,000 cm⁻¹ or more. Preferably, the light absorption coefficient is 3,000 cm⁻¹ or more. More preferably, also in the infrared ray region (800 to 2,000 nm), the light absorption coefficient is 1,000 cm⁻¹ or more, more preferably, 3,000 cm⁻¹ or more. As the reason why the GaN-based, GaAlN-based, or AlN-based compound semiconductor of the present invention has a high light absorption coefficient is that the unoccupied state of the impurity band and the ground state of the electrons are well balanced, meaning that the possibility for transition itself is high, and indicating that the compound semiconductor can achieve higher conversion efficiency as the photoelectric conversion material. As used herein, the light absorption coefficient indicates a ratio of absorption of light during traveling in a unit length, and the unit is cm⁻¹.

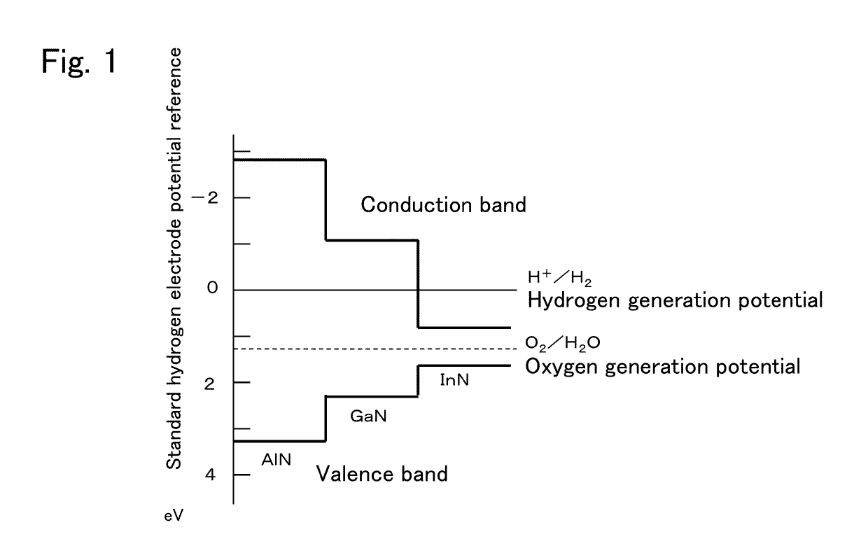

FIG. 1 is a schematic diagram showing a relationship between a band level of main nitride semiconductor and a redox potential. The vertical axis represents a redox potential (normal hydrogen electrode standard (NHE)). A hydrogen generating potential is 0 V (vs. NHE), and an oxygen generating potential is 1.23 V (vs. NHE). For generation of oxygen, the top of the valence band of a semiconductor used as a photocatalyst needs to be more positive than the oxygen generating potential. For generation of hydrogen, the bottom of the conduction band of a semiconductor used as a photocatalyst needs to be more negative than the hydrogen generating potential. As is understood from FIG. 1, a nitride-based compound semiconductor (Al_{1-y}Ga_{y})₁₋ₓTₓN, which is a photocatalyst material of the present invention, has an intermediate band and can absorb light in the visible ray region and the infrared ray region as well as in the ultraviolet ray region of sunlight to excite electrons to the conduction band and excite holes to the valence band. Even if the compound semiconductor has an intermediate band, the positions of the conduction band and the valence band remain unchanged. Thus, the following conditions are also satisfied. That is, the photocatalyst material of the present invention satisfies the following conditions: (1) due to the intermediate band, a light absorption coefficient in an entire region including the visible ray region and the infrared ray region as well as the ultraviolet ray region of sunlight is high; (2) the energy level of the bottom of the conduction band is more negative than the redox potential of H⁺/H₂ (for production of oxygen, the top of the valence band is more positive than the redox potential of O₂/H₂O); and (3) there is no or little degradation of a material even when the material is irradiated with light underwater. Further, as is understood from FIG. 1, if the content of Al is increased in AlGaMnN wherein y<1, the band gap is widened, and thus, reducing power of electrons activated to the conduction band and oxidizing power of holes activated to the valence band by light absorption increase. Accordingly, a photocatalyst device with higher efficiency can be provided.

The nitride-based compound semiconductor of the present invention, such as GaTN, GaAlTN, or AlTN, can be produced by a molecular beam epitaxy method (MBE method), which uses nitrogen atoms-containing gas, such as ammonia or hydrazine, as a nitrogen source. In the MBE method, the nitrogen atom-containing gas is introduced into a vacuum atmosphere, and, while the nitrogen atom-containing gas is subjected to photodecomposition or thermal decomposition on the substrate or in the vicinity thereof, the substrate is irradiated with metal molecular beams of Ga or Al, and the 3d-transition metal T so as to allow GaTN, GaAlTN, or AlTN to grow. The concentration of the 3d-transition metal T can be changed by adjustment of a temperature of the 3d-transition metal element cell at the time of film formation so as to adjust a supplied amount thereof.

Further, the nitride-based compound semiconductor of the present invention, such as GaTN, GaAlTN, or AlTN, can also be produced by a high-frequency sputtering method. Film formation by sputtering can facilitate composition change and is suitable for forming a film in a large area, and is thus suitable for producing a GaN-based, GaAlN-based, or AlN-based nitride-based compound semiconductor film of the present invention. According to the sputtering method, a substrate and a GaN, GaAlN, or AlN target are placed in a vacuum chamber, and a mixed gas of nitrogen and argon is introduced into the chamber to generate plasma through high frequency. Sputtered GaN, GaAlN, or AlN is deposited on the substrate to form a film. At this time, by placing a 3d-transition metal chip on the GaN, GaAlN, or AlN target, a GaN-based compound semiconductor in which Ga and/or Al is replaced by a 3d-transition metal is obtained. Further, a replacement amount can be arbitrarily adjusted by a method of changing the area, the number, or the arrangement of 3d-transition metal chips, or the like. Moreover, the GaN-based, GaAlN-based, or AlN-based nitride compound semiconductor produced by the sputtering method shows a microcrystal or amorphous-like structure.

For example, when Hall effect measurement of Ga₁₋ₓMnₓN produced by the MBE method was conducted by the van der Pauw's method, Ga₁₋ₓMnₓN exhibited p-type conductivity, and a carrier concentration when x was 0.068 was 2×10²⁰/cm³.

On the other hand, when Hall effect measurement of a GaN-based film (GaTdN) obtained by replacement of part of Ga by a 3d-transition metal produced by the sputtering method was conducted by the van der Pauw's method, the GaN-based film exhibited n-type conductivity. The reason that the type of conductivity varies depending upon the film formation method is unclear, but currently the reason is being studied.

Up to here, the embodiments where the photocatalyst material is formed only of a nitride-based compound semiconductor such as GaTN, GaAlTN, or AlTN have been described. However, the present invention also includes a photocatalyst material which has a structure in which other semiconductor layers are laminated on a layer of the nitride-based compound semiconductor such as GaTN, GaAlTN, or AlTN.

Of the nitride-based compound semiconductors of the present invention, such as GaTN, GaAlTN, or AlTN, one produced by the MBE method has high crystallinity, and one produced by the sputtering method has a microcrystal or amorphous-like structure. In the case where the nitride-based compound semiconductor is produced by the MBE method, the nitride-based compound semiconductor has a lattice constant similar to that of a GaN-based, GaAlN-based, or AlN-based nitride-based compound semiconductor, and can form a lattice-matched pn-junction. Thus, for example, on a first semiconductor layer formed of a nitride-based compound semiconductor such as GaTN, GaAlTN, or AlTN, a second semiconductor layer formed of a compound represented by a general formula Al₁₋ₓGaₘN (0≦m≦1, m may be the same as y) such as a GaN-based, GaAlN-based, or AlN-based compound can be laminated. It is preferred that the first semiconductor layer and the second semiconductor layer form a pn-junction. For example, if the GaTN of the present invention grows on an n-GaN film by the MBE method, a hetero pn-junction of p-GaTN/n-GaN or p-GaTN/n-GaN can be formed. Alternatively, by forming a film of GaTN in which part of Ga is replaced by a 3d-transition metal on a p-GaN substrate by sputtering, a hetero pn-junction of p-GaN/n-GaTN can be formed.

The first semiconductor layer formed of a nitride-based compound semiconductor such as GaTN, GaAlTN, or AlTN can be formed of two layers forming a pn-junction. For example, p-GaTN is obtained by injecting an acceptor dopant and n-GaTN is obtained by injecting a donor dopant. Thus, n-GaTN/p-GaTN can be produced.

Further, the first semiconductor layer, an intermediate layer, and the second semiconductor layer may be laminated, in which the intermediate layer is formed of a nitride-based compound semiconductor such as GaTN, GaAlTN, or AlTN, and the first semiconductor layer and the second semiconductor layer are formed of a compound represented by a general formula Al₁₋ₙGaₙN (0≦n≦1, n may be the same as y).

Further, the form of the photocatalyst material of the present invention is not particularly limited and may be a film or powder.

The photocatalyst device of the present invention is not particularly limited as long as the photocatalyst device uses the photocatalyst material of the present invention. Specific examples thereof include a photocatalyst device for generating hydrogen, in which hydrogen is obtained from water (aqueous solution), and a photocatalyst device for decomposing a harmful substance, in which a harmful substance is decomposed and detoxified by redox reaction of electrons and holes.

As the photocatalyst device for generating hydrogen, there is a device including a photocatalyst material and soaking means for soaking the photocatalyst material in an aqueous solution (or water), wherein the photocatalyst material is irradiated with sunlight to decompose the aqueous solution and generate hydrogen. Further, there is a device including a cathode and an anode connected electrically to each other and soaking means for soaking the cathode and the anode in an aqueous solution, the anode or the cathode being formed of a photocatalyst material, wherein the photocatalyst material is irradiated with sunlight to decompose the aqueous solution and generate hydrogen. As the soaking means, a water tank can be used. The shape of the water tank is not particularly limited as long as the water tank allows the photocatalyst material to be irradiated with sunlight. Further, if required, supply means such as a pump for supplying an aqueous solution continuously may be used to supply the aqueous solution continuously to the water tank.

### First Embodiment

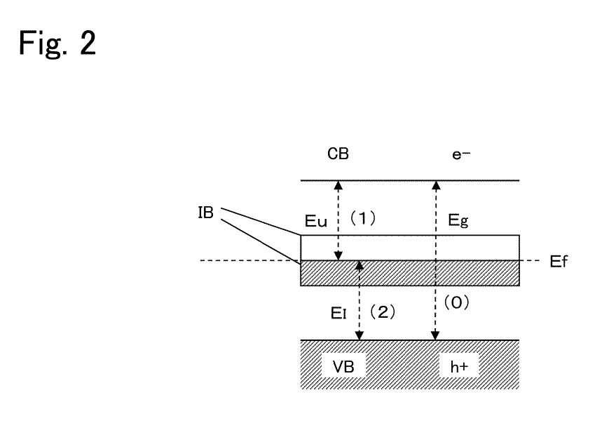

FIG. 2 is a schematic view illustrating an example of a band structure of GaMnN of the present invention. In FIG. 2, symbol VB denotes a valence band; CB, a conduction band; IB, an intermediate band formed of an impurity band; E_{g}, a band gap of GaMnN; E_{f}, a Fermi level; Eᵤ, a band gap between the impurity band and the conduction band; and Eₗ, a band gap between the valence band and the impurity band. Here, even when the intermediate band is present, the band gap E_{g} of GaMnN is the same as a band gap of GaN without Mn added thereto. By radiation of sunlight to GaMnN, three types of excitations occur as follows: electrons e⁻ are directly excited by ultraviolet rays from the valence band VB to the conduction band CB (represented by (0) in FIG. 2); electrons e⁻ are excited by visible rays and infrared rays from the valence band VB to an unoccupied portion of the impurity band IB through the intermediate band IB (represented by (2) in FIG. 2); and electrons e⁻ are excited from the occupied portion of the intermediate band IB to the conduction band CB (represented by (1) in FIG. 2). By those excitations, a large number of electrons e⁻ come to exist in the conduction band CB, and a large number of holes h⁺ come to exist in the valence band VB. The direct excitation (0) and excitations (1) and (2) through the impurity band IB are possible. Therefore, the photocatalyst material of the present invention can absorb sunlight in a broad wavelength range including not only ultraviolet rays but also visible rays and infrared rays as described above, and can excite charge carriers with high efficiency. That is, the photocatalyst material of the present invention has a great feature of having an intermediate band capable of exciting electrons e⁻.

Although only Mn is used as the 3d-transition metal herein, if a plurality of 3d-transition metals selected from the group consisting of Sc, Ti, V, Cr, Mn, Fe, Co, Ni, and Cu are used, a plurality of intermediate bands can be formed, and photoelectric conversion efficiency can be enhanced further.

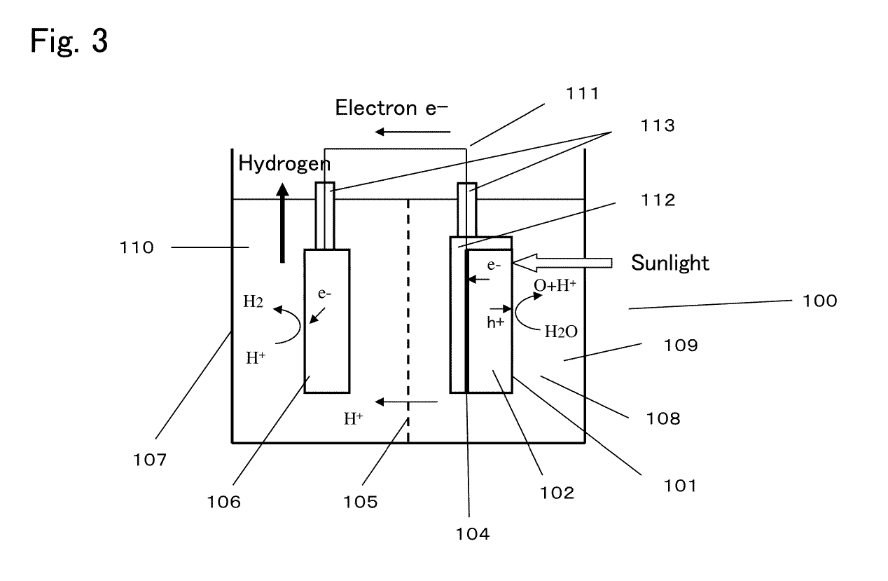

FIG. 3 is a schematic view illustrating a structure of a photocatalyst device 100 using, as an anode, a photocatalyst material including a GaMnN layer whose band structure is illustrated in FIG. 2. A water tank 107 is filled with pure water or an electrolyte aqueous solution 108 and divided into an anode chamber 109 and a cathode chamber 110 by an ion exchange membrane 105. A platinum plate is placed as a cathode 106 in the cathode chamber 110, and an anode 101 is placed in the anode chamber 109. The anode 101 is formed of a GaMnN layer 102, and a charge extracting electrode 104 is formed on a rear surface of the GaMnN layer 102. Further, the charge extracting electrode 104 is coated with a waterproof insulating film 112 so as not to come into direct contact with the electrolyte aqueous solution 108. Numeral 113 denotes waterproof insulating tubes for preventing a conductive wire 111 from coming into direct contact with the electrolyte aqueous solution 108.

When the GaMnN layer 102 of the anode 101 is irradiated with sunlight, charge carriers are effectively excited with a broad range of wavelength components of ultraviolet rays, visible rays, and infrared rays of sunlight, as described above. The excited electrons e⁻ move from the charge extracting electrode 104 to the cathode 106 through the conductive wire 111. On the front surface of the GaMnN layer 102, the holes h⁺ react with the electrolyte aqueous solution 108 to generate oxygen and hydrogen ions due to an oxidation function of the holes h⁺. Then, the hydrogen ions move to the cathode chamber 110 through the ion exchange membrane 105, and hydrogen is generated in the cathode 106 due to a reduction function of electrons. Here, although the same solution is used as the electrolyte solution 108, different solutions may be used in the cathode chamber 110 and the anode chamber 109.

In this case, if n-type GaMnN doped with a donor dopant is used, a Fermi level rises, and hydrogen generation efficiency is enhanced. Further, although platinum is used as the cathode, materials such as carbon, platinum-supported carbon, nickel, copper, zinc, ruthenium, and rhodium can be used. Carbon, a semiconductor, or ceramics supporting the above-mentioned metal(s) can also be used.

### Second Embodiment

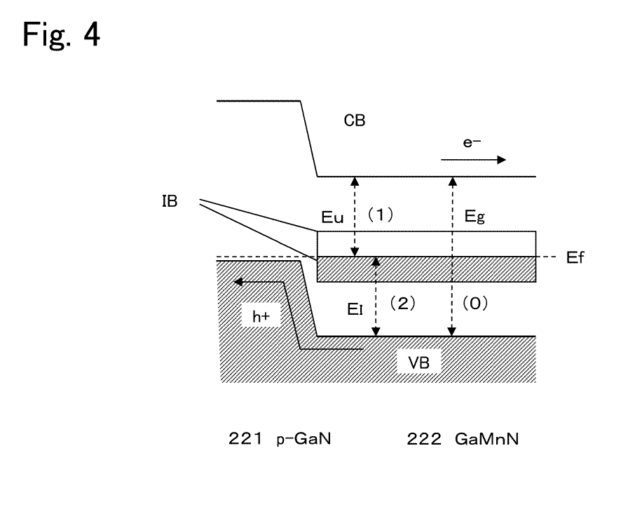

FIG. 4 is a schematic view illustrating an example of a band structure which is a laminated structure of p-GaN/GaMnN. In FIG. 4, symbol 221 denotes a p-GaN layer; 222, a GaMnN layer; VB, a valence band; CB, a conduction band; IB, an intermediate band formed of an impurity band; E_{g}, a band gap of GaMnN; E_{f}, a Fermi level; Eᵤ, a band gap between the impurity band and the conduction band; and Eₗ, a band gap between the valence band and the impurity band. FIG. 4 illustrates that, by radiation of light to the GaMnN layer 222, electrons e⁻ are directly excited from the valence band to the conduction band (0); electrons are excited from the valence band to an unoccupied portion of the impurity band through the impurity band (2); and electrons are excited from an occupied portion of the impurity band to the conduction band (1). The excited electrons e⁻ are blocked by the p-GaN layer 221 and stay in the GaMnN layer 222, and the holes h⁺ move to the p-GaN layer 221, with the result that charge carriers are separated. Although the electrons e⁻ are directly excited from the valence band to the conduction band in the p-GaN layer 221 due to radiation of ultraviolet rays, the basic operation remains unchanged, and thus, illustration of the direct excitation is omitted in FIG. 4 for clarifying the description.

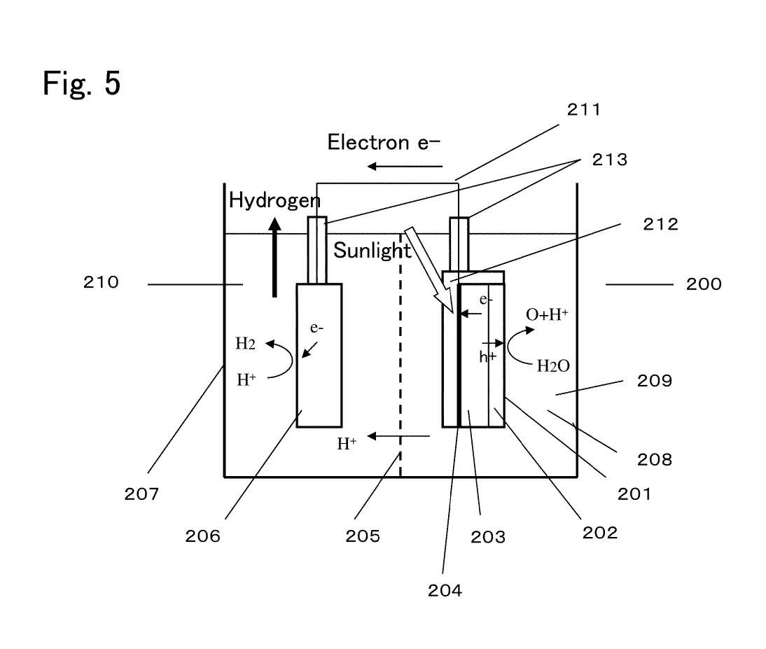

FIG. 5 is a schematic view illustrating a structure of a photocatalyst device 200 using, as an anode, a photocatalyst material having the laminated structure of p-GaN/GaMnN in FIG. 4. A water tank 207 is filled with pure water or an electrolyte aqueous solution 208 and divided into an anode chamber 209 and a cathode chamber 210 by an ion exchange membrane 205. A platinum plate is placed as a cathode 206 in the cathode chamber 210, and an anode 201 is placed in the anode chamber 209. The anode 201 has a structure in which p-GaN 202 is laminated on one principal surface of a GaMnN layer 203, and a charge extracting electrode 204 is formed on the other principal surface of the GaMnN layer 203. The charge extracting electrode 204 is coated with a waterproof insulating film 212 so as not to come into direct contact with the electrolyte aqueous solution 208. Numeral 213 denotes waterproof insulating tubes for preventing a conductive wire 211 from coming into direct contact with the electrolyte aqueous solution 208.

When the GaMnN layer 203 of the anode 201 is irradiated with sunlight, charge carriers are excited. The holes h⁺ excited to the valence band of the GaMnN layer 203 move to the p-GaN layer 202, and the electrons e⁻ excited to the conduction band of the GaMnN layer 203 move to the surface of the GaMnN layer 203. The electrons e move from the charge extracting electrode 204 to the cathode 206 through the conductive wire 211. On the surface of the p-GaN layer 202 of the anode 200, the holes h⁺ react with water to generate oxygen and hydrogen ions due to an oxidation function of the holes h⁺. Then, the hydrogen ions move to the cathode chamber 210 through the ion exchange membrane 205, and hydrogen is generated in the cathode 206 due to a reduction function of electrons. In order to enhance carrier separation and moving efficiency by an internal electric field, as the GaMnN layer 203, an n-type GaMnN layer doped with a donor dopant can be used.

### Third Embodiment

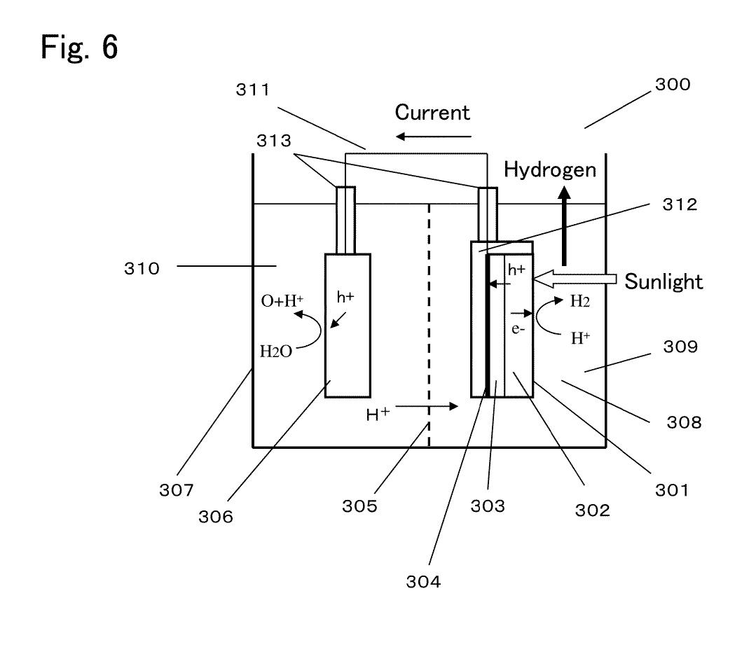

FIG. 6 is a schematic view illustrating a structure of a photocatalyst device 300 using, as a cathode, the photocatalyst material having the laminated structure of p-GaN/GaMnN illustrated in FIG. 4. A water tank 307 is filled with pure water or an electrolyte aqueous solution 308 and divided into a cathode chamber 309 and an anode chamber 310 by an ion exchange membrane 305. A platinum plate is placed as an anode 306 in the anode chamber 310, and a cathode 301 is placed in the cathode chamber 309. The cathode 301 has a structure in which a GaMnN layer 302 is laminated on one principal surface of a p-GaN layer 303, and a charge extracting electrode 304 is formed on the other principal surface of the p-GaN layer 303. The charge extracting electrode 304 is coated with a waterproof insulating film 312 so as not to come into direct contact with the electrolyte aqueous solution 308. Numeral 313 denotes waterproof insulating tubes for preventing a conductive wire 311 from coming into direct contact with the electrolyte aqueous solution 308.

When the GaMnN layer 302 of the cathode 301 is irradiated with sunlight, charge carriers are excited. Holes h⁺ excited to the valence band of the GaMnN layer 302 move to the p-GaN layer 303, and electrons e⁻ excited to the conduction band of the GaMnN layer 302 move to the surface of the GaMnN layer 302. Then, a current flows from the charge extracting electrode 304 to the anode 306 through the conductive wire 311. In the anode 306, the holes h⁺ react with water to generate oxygen and hydrogen ions due to an oxidation function of the holes h⁺. Then, the hydrogen ions move through the ion exchange membrane 305, and hydrogen is generated on the surface of the p-GaN layer 303 of the cathode 301 due to a reduction function of electrons. In order to enhance charge carrier separation and moving efficiency by an internal electric field, as the GaMnN layer 302, an n-type GaMnN layer doped with a donor dopant can be used.

Although platinum is used as the anode here, materials such as carbon, platinum-supported carbon, nickel, copper, zinc, ruthenium, and rhodium can be used. Carbon, a semiconductor, or ceramics supporting the above-mentioned metal(s) can be used.

### Fourth Embodiment

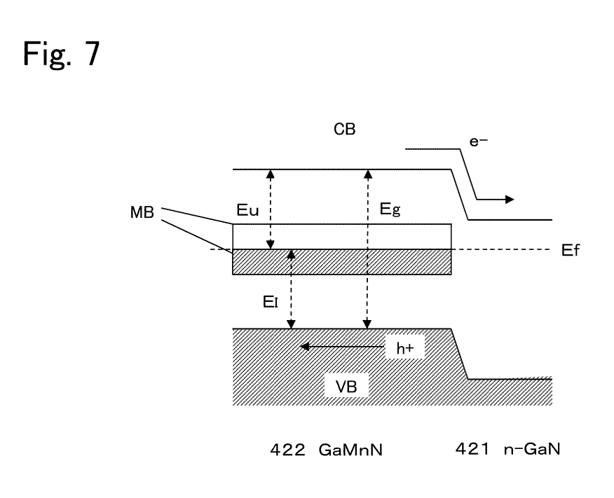

FIG. 7 is a schematic view illustrating another example of a band structure which is a laminated structure of n-GaN/GaMnN. In FIG. 7, symbol 421 denotes an n-GaN layer; 422, a GaMnN layer; VB, a valence band; CB, a conduction band; MB, an intermediate band formed of an impurity band; E_{g}, a band gap of GaN; E_{f}, a Fermi level; Eᵤ, a band gap between the impurity band and the conduction band; and Eₗ, a band gap between the valence band and the impurity band. FIG. 7 illustrates that electrons are excited from the valence band to the conduction band by radiation of light; electrons are excited from the valence band to an unoccupied portion of the impurity band (2); and electrons are excited from an occupied portion of the impurity band to the conduction band (1). The electrons e generated by excitation with light move to the n-GaN layer 421, whereas holes h⁺ are blocked by the n-GaN layer 421 to stay in the GaMnN layer 422. Although the electrons e⁻ are excited directly from the valence band to the conduction band also in the n-GaN layer 421 by radiation of ultraviolet rays, the basic operation remains unchanged, and thus, illustration of the direct excitation is omitted in FIG. 7 for clarifying the description.

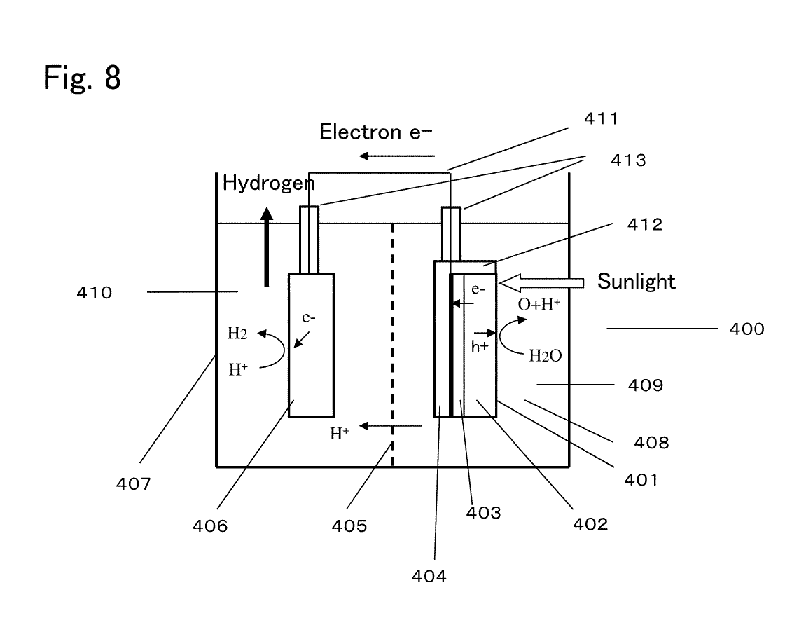

FIG. 8 is a schematic view illustrating a structure of a photocatalyst device 400 using, as an anode, the photocatalyst material having the laminated structure of n-GaN/GaMnN of FIG. 7. A water tank 407 is filled with pure water or an electrolyte aqueous solution 408 and divided into a cathode chamber 410 and an anode chamber 409 by an ion exchange membrane 405. A platinum plate is placed as a cathode 406 in the cathode chamber 410, and an anode 401 is placed in the anode chamber 409. The anode 401 has a structure in which the GaMnN layer 402 is laminated on one principal surface of an N—GaN layer 403, and a charge extracting electrode 404 is formed on the other principal surface of the n-GaN layer 403. The charge extracting electrode 404 is coated with a waterproof insulating film 412 so as not to come into direct contact with the electrolyte aqueous solution 408. Numeral 413 denotes waterproof insulating tubes for preventing a conductive wire 411 from coming into direct contact with the electrolyte aqueous solution 408.

When the GaMnN layer 402 of the anode 401 is irradiated with sunlight, electrons e⁻ are excited. Holes h⁺ excited to the valence band of the GaMnN layer 402 move to the surface of the GaMnN layer 402, and electrons e⁻ excited to the conduction band of the GaMnN layer 402 move to the n-GaN layer 403. Further, the electrons e move from the charge extracting electrode 404 to the cathode 406 through the conductive wire 411. In the n-GaN layer 403, the holes h⁺ react with water to generate oxygen and hydrogen ions due to an oxidation function of the holes h⁺. Then, the hydrogen ions move through the ion exchange membrane 405 to the cathode chamber 410, and hydrogen is generated in the cathode 406 due to a reduction function of electrons. In order to enhance carrier separation and moving efficiency, as the GaMnN layer 402, a p-type GaMnN layer doped with an acceptor dopant can be used.

Although platinum is used as the cathode, materials such as carbon, platinum-supported carbon, nickel, copper, zinc, ruthenium, and rhodium can be used. Carbon, a semiconductor, or ceramics supporting the above-mentioned metal(s) can be used.

### Fifth Embodiment

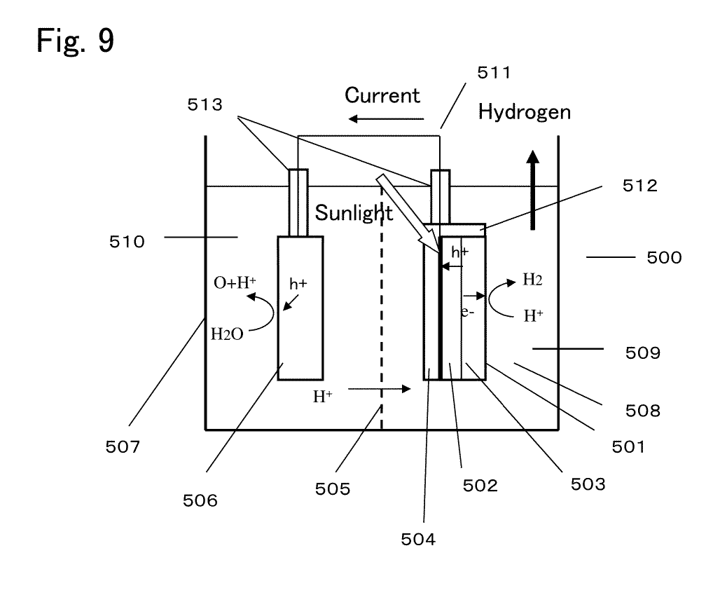

FIG. 9 is a schematic view illustrating a structure of a photocatalyst device 500 using, as a cathode, the photocatalyst material having the laminated structure of n-GaN/GaMnN illustrated in FIG. 7. A water tank 507 is filled with pure water or an electrolyte aqueous solution 508 and divided into a cathode chamber 509 and an anode chamber 510 by an ion exchange membrane 505. A platinum plate is placed as an anode 506 in the anode chamber 510, and a cathode 501 is placed in the cathode chamber 509. The cathode 501 has a structure in which an n-GaN layer 503 is laminated on one principal surface of a GaMnN layer 502, and a charge extracting electrode 504 is formed on the other principal surface of the n-GaN layer 503. The charge extracting electrode 508 is coated with a waterproof insulating film 512 so as not to come into direct contact with the electrolyte aqueous solution 508. Numeral 513 denotes waterproof insulating tubes for preventing a conductive wire 511 from coming into direct contact with the electrolyte aqueous solution 508.

When the GaMnN layer 502 of the cathode 501 is irradiated with sunlight, electrons e⁻ are excited. Holes h⁺ excited to the valence band of the GaMnN layer 502 move to the surface of the GaMnN layer 502, and electrons e⁻ excited to the conduction band of the GaMnN layer 502 move to the n-GaN layer 503. Then, a current flows from the charge extracting electrode 504 to the anode 506 through the conductive wire 511. In the anode 506, the holes h⁺ react with water to generate oxygen and hydrogen ions due to an oxidation function of the holes h⁺. Then, the hydrogen ions move through the ion exchange membrane 505 to the cathode chamber 509, and hydrogen is generated on the n-GaN layer 503 due to a reduction function of electrons. Further, in order to enhance carrier separation and moving efficiency, as the GaMnN layer 502, a p-type GaMnN layer doped with an acceptor dopant can be used.

Although platinum is used as the anode, materials such as carbon, platinum-supported carbon, nickel, copper, zinc, ruthenium, and rhodium can be used. Carbon, a semiconductor, or ceramics supporting the above-mentioned metal(s) can be used.

The first embodiment is described using a photocatalyst material of GaMnN alone, and the second to fifth embodiments are described using photocatalyst materials having a laminated structure such as p-GaN/GaMnN or n-GaN/GaMnN. However, a photocatalyst material having a laminated structure of p-GaMnN/GaMnN or n-GaMnN/GaMnN can also be used.

### Sixth Embodiment

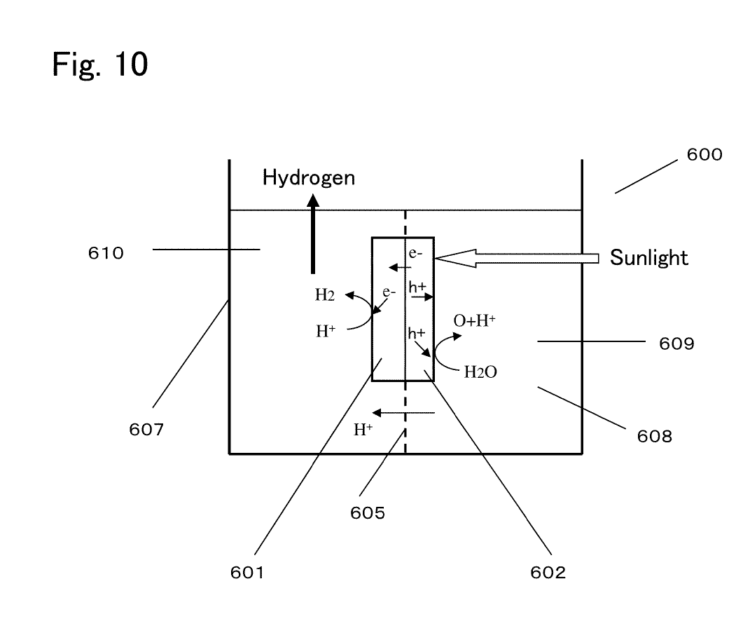

FIG. 10 is a schematic view illustrating a structure of a photocatalyst device 600 using a photocatalyst material having a laminated structure of p-GaMnN/n-GaMnN. Numeral 601 denotes an n-GaMnN layer and numeral 602 denotes a p-GaMnN layer. A water tank 607 is filled with pure water or an electrolyte aqueous solution 608, and is divided into a cathode chamber 610 and an anode chamber 609 by an ion exchange membrane 605, with a junction surface of the laminated structure of p-GaMnN/n-GaMnN being a border. The n-GaMnN layer 601 is held in contact with the electrolyte aqueous solution 608 in the cathode chamber 610, and the p-GaMnN layer 602 is held in contact with the electrolyte aqueous solution 608 in the anode chamber 609. When one side or both sides of the n-GaMnN layer 601 or the p-GaMnN layer 602 are irradiated with sunlight (in FIG. 10, only the p-GaMnN layer 602 is irradiated with light), charge carriers are excited. Holes h⁺ excited to the valence band move to the p-GaMnN layer 602, and electrons e⁻ excited to the conduction band move to the n-GaMnN layer 601. On the surface of the p-GaMnN layer 602, the holes h⁺ react with water to generate oxygen and hydrogen ions due to the oxidation function of the holes h⁺. Then, the hydrogen ions move through the ion exchange membrane 605 to the cathode chamber 610, and hydrogen is generated on the n-GaMnN layer 601 side due to the reduction function of the electrons.

Although the photocatalyst material having a laminated structure of p-GaMnN/n-GaMnN is used herein, a photocatalyst material having a laminated structure of p-GaN/n-GaMnN, a photocatalyst material having a laminated structure of p-GaMnN/n-GaN, or the like can also be used. Note that, an n-GaMnN or p-GaMnN side is mainly irradiated with sunlight.

In the first to sixth embodiments, although an example of a photocatalyst material using GaN as a parent material and Mn as a 3d-transition metal has been described, even in the case of using GaAlN or AlN as the parent material and at least one kind selected from the group consisting of Sc, Ti, V, Cr, Fe, Co, Ni, and Cu other than Mn as a 3d-transition metal, a photocatalyst device can be configured in the same way as in the cases of the first to fifth embodiments.

Further, in the first to sixth embodiments described above, although the photocatalyst material of the present invention is formed as a thin film to be used an electrode, the photocatalyst material of the present invention may be formed into a particle shape to be supported on an electrode material. For example, an electrode in which the photocatalyst material of the present invention is supported on an electrode material includes an electrode in which the photocatalyst material of the present invention is supported on a stainless plate excellent in durability.

Further, in the first to sixth embodiments, although an example of a photocatalyst device using an electrode formed of the photocatalyst material of the present invention has been described, as another embodiment of the photocatalyst device of the present invention, an embodiment of generating hydrogen using a method of dispersing the photocatalyst material of the present invention in a water tank containing an aqueous solution and irradiating the aqueous solution with sunlight can also be used.

### Seventh Embodiment

In the first to sixth embodiments, an example using GaMnN as a photocatalyst material has been described. However, as another photocatalyst material, embodiments using materials such as GaCoN using GaN as a parent material and Co as a 3d-transition metal, AlNiN using AlN as a parent material and Ni as a 3d-transition metal, and AlGaNiN using AlGaN as a parent material and Ni as a 3d-transition metal are described next.

First, an embodiment using GaCoN as a photocatalyst material is described.

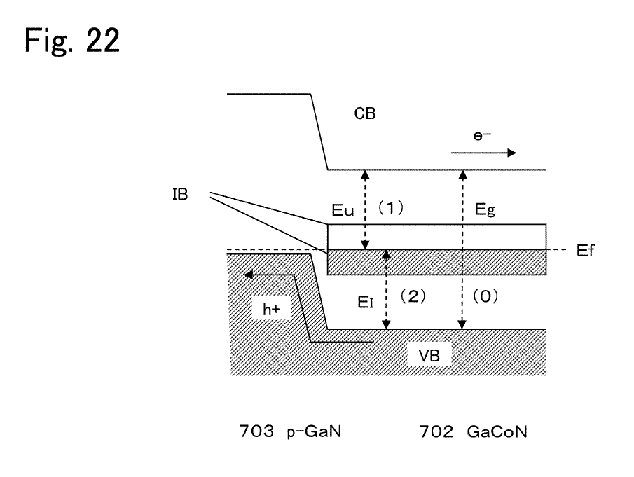

FIG. 22 is a schematic view illustrating an example of a band structure of a laminated structure of p-GaN/GaCoN, in which GaCoN is formed on p-type GaN. In FIG. 22, symbol 703 denotes a p-GaN layer; 702, a GaCoN layer; VB, a valence band; CB, a conduction band; IB, an intermediate band formed of an impurity band; E_{g}, a band gap of GaCoN; E_{f}, a Fermi level; Eᵤ, a band gap between the impurity band and the conduction band; and Eₗ, a band gap between the valence band and the impurity band. Chain-line arrows in FIG. 22 show that, when the GaCoN layer 702 is irradiated with sunlight, the following excitations occur: electrons e⁻ are directly excited from the valence band to the conduction band (0); electrons are excited from the valence band to an unoccupied portion of the impurity band through the impurity band (2); and electrons are excited from an occupied portion of the impurity band to the conduction band (1). The excited electrons e⁻ are blocked by the p-GaN layer 703 and stay in the GaCoN layer 702. Holes h⁺ move to the p-GaN layer 703 and charge carriers are separated.

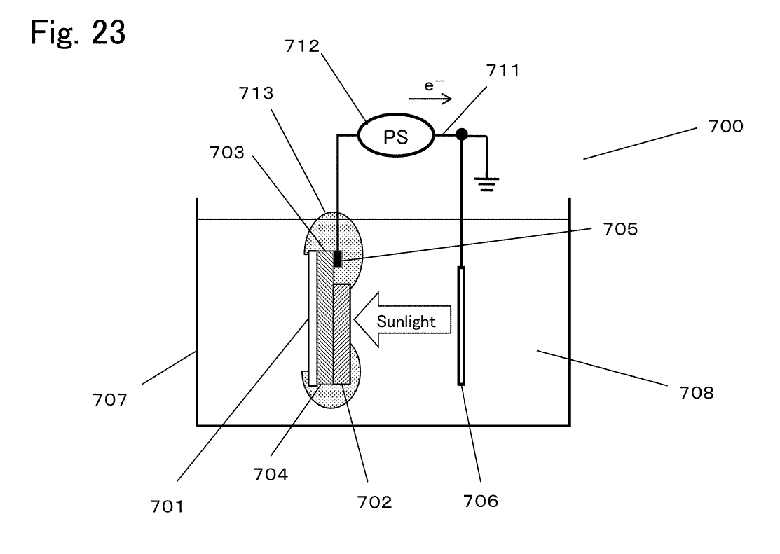

FIG. 23 is a schematic view illustrating a structure of a photocatalyst device 700 using, as a semiconductor electrode 704, a structure in which the p-GaN 703/GaCoN 702 illustrated in FIG. 22 is laminated on a sapphire substrate 701 by sputtering (MBE method can also be used). Here, as the photocatalyst material GaCoN 702, a material having a composition containing 87% Ga and 13% Co is used. A water tank 707 is filled with 1 mol/L of a hydrochloric acid aqueous solution as an electrolyte aqueous solution 708. Further, in the water tank 707, a platinum electrode 706 is placed as a cathode electrode together with the semiconductor electrode 704 placed as an anode electrode. The GaCoN layer 702 is laminated on one principal surface of the p-GaN layer 703, and a charge extracting electrode 705 is formed on a junction surface of the p-GaN layer 703 and the GaCoN layer 702. The charge extracting electrode 705 is coated with an epoxy resin as a waterproof insulating film 713 so as not to come into direct contact with the electrolyte aqueous solution 708. Numeral 712 denotes an external power source for applying a voltage to the charge extracting electrode 705, and a conductive wire 711 serves to electrically connect the charge extracting electrode 705 to the platinum electrode 706.

When the GaCoN layer 702 is irradiated with sunlight, electrons are exited in three stages: from the valence band to the conduction band; from the valence band to the unoccupied portion of the impurity band through the impurity band; and from the occupied portion of the impurity band to the conduction band. The holes h⁺ excited to the valence band of the GaCoN layer 702 move to the p-GaN layer 703, and the electrons e⁻ excited to the conduction band of the GaCoN layer 702 stay in the GaCoN layer 702. Then, the electrons e⁻ flow from the charge extracting electrode 705 to the platinum electrode 706 through the conductive wire 711.

When a voltage of −3 V to +2.5 V was applied to the charge extracting electrode 705 by the external power source 712 under a state in which light was not radiated, generation of hydrogen was not observed on the semiconductor electrode 704 and the platinum electrode 706. When a voltage of +2.2 V or more was applied to the charge extracting electrode 705 by the external power source 712 under a state in which sunlight was radiated, generation of hydrogen was observed on the semiconductor electrode 704 and the platinum electrode 706. Further, when a voltage of −0.3 V or less was applied, generation of a great amount of hydrogen was observed on the platinum electrode 706. Further, when a voltage of −0.3 V or less was applied to the charge extracting electrode 705 by the external power source 712 even under a state of radiation of only visible rays, instead of light in ultraviolet, visible, and infrared regions such as sunlight, generation of a great amount of hydrogen was observed on the platinum electrode 706. This phenomenon shows that, in GaN, electrons are not excited by radiation of visible rays because the band gap is about 3.4 eV, whereas, in the GaCoN layer 702, electrons are excited even by radiation of visible rays because of the intermediate band caused by the addition of the 3d-transition metal Co. Thus, compared with a conventional photocatalyst material in which only single electron excitation from the valence band to the conduction band by ultraviolet rays is performed as in titanium oxide TiO₂, light in ultraviolet, visible, and infrared regions contained in sunlight can be used effectively for generating hydrogen. In principle, the external power source 712 for applying a voltage to the charge extracting electrode 704 is not required. However, in this experiment, the external power source 712 was necessary for generating hydrogen. Although various defects in the semiconductor electrode 704 can be considered for this reason, the detail is not clear, and more detailed analysis is planned to be conducted.

### Eighth Embodiment

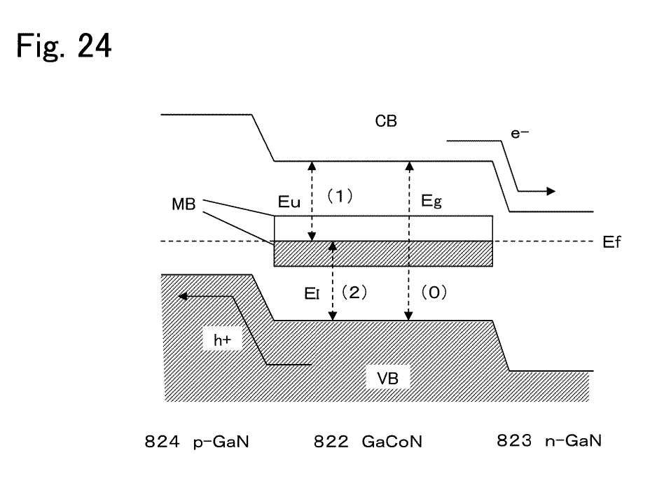

FIG. 24 is a schematic view illustrating an example of a band structure which is a pan laminated structure of p-GaN/GaCoN/n-GaN. In FIG. 24, symbol 824 denotes a p-GaN layer; 822, a GaCoN layer as a photocatalyst material; 823, an n-GaN layer; VB, a valence band; CB, a conduction band; IB, an intermediate band formed of an impurity band; E_{g}, a band gap of GaMnN; E_{f}, a Fermi level; Eᵤ, a band gap between the impurity band and the conduction band; and Eₗ, a band gap between the valence band and the impurity band. Chain-line arrows in FIG. 24 show that, when the GaCoN layer 822 is irradiated with sunlight, the following excitations occur: electrons e⁻ are directly excited from the valence band to the conduction band (0); electrons are excited from the valence band to an unoccupied portion of the impurity band through the impurity band (2); and electrons are excited from an occupied portion of the impurity band to the conduction band (1). The excited electrons e⁻ are blocked by the p-GaN layer 824 and move to the n-GaN layer 823. Holes h⁺ are blocked by the n-GaN layer 823 and move to the p-GaN layer 824, and charge carriers are separated.

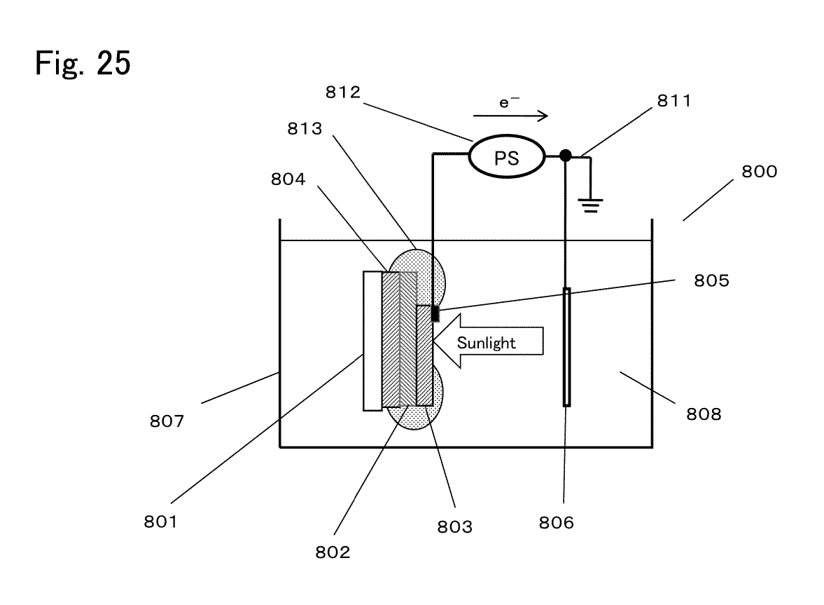

FIG. 25 is a schematic view illustrating a structure of a photocatalyst device 800 using, as a semiconductor electrode, a structure in which p-GaN 804/GaCoN (thickness: 300 nm) 802/n-GaN (thickness: 250 nm) 803 similar to the pan structure illustrated in FIG. 24 are laminated on a sapphire substrate 801. As the photocatalyst material GaCoN 802, a material having a composition containing 93.5% Ga and 6.5% Co is used. A water tank 807 is filled with 1 mol/L of a hydrochloric acid aqueous solution as an electrolyte aqueous solution 808. In the water tank 807, a platinum electrode 806 is placed as an electrode together with the semiconductor electrode. The GaCoN layer 802 is formed on one principal surface of the p-GaN layer 803 formed on the sapphire substrate 801, and the n-GaN layer 804 is formed on the GaCoN layer 802. Further, a charge extracting electrode 805 is formed on one principal surface of the n-GaN 803. The charge extracting electrode 805 is coated with an epoxy resin as a waterproof insulating film 813 so as not to come into direct contact with the electrolyte aqueous solution 808. Numeral 812 denotes an external power source for applying a voltage to the charge extracting electrode 805. A conductive wire 811 serves to electrically connect the charge extracting electrode 805 to the platinum electrode 806.

When the GaCoN layer 802 of FIG. 25 is irradiated with sunlight, electrons are excited in three stages as described above. Holes h⁺ excited to the valence band of the GaCoN layer 802 move to the p-GaN layer 804, and electrons e⁻ excited to the conduction band of the GaCoN layer 802 move to the surface of the n-GaN layer 803. Then, the electrons e⁻ flow from the charge extracting electrode 805 to the platinum plate 806 through the conductive wire 811. When a voltage was not applied to the charge extracting electrode 805 by the external power source 812 under a state in which the GaCoN layer 802 was irradiated with sunlight or visible rays, hydrogen was generated on the side of the n-GaN layer 803. When a negative voltage was applied to the charge extracting electrode 805 by the external power source 812 under a state in which the GaCoN layer 802 was irradiated with sunlight, hydrogen was generated mainly from the platinum electrode 806 side, and when a positive voltage was applied to the charge extracting electrode 805 under a state in which the GaCoN layer 802 was irradiated with sunlight, hydrogen was generated mainly on the side of n-GaN layer 803. Further, generation of a great amount of hydrogen was observed by a similar method even when the GaCoN layer 802 was irradiated only with visible rays. This phenomenon shows that electrons are excited from the intermediate band by radiation of visible rays, as described above. In principle of operation, the external power source 812 is not required. However, in this experiment, the external power source 812 was necessary for generating hydrogen at high efficiency. Although various defects in the p-GaN 804/GaCoN 802/n-GaN 803 structure forming the semiconductor electrode can be considered for this reason, the detail is not clear, and more detailed analysis is planned be conducted.

### Ninth Embodiment

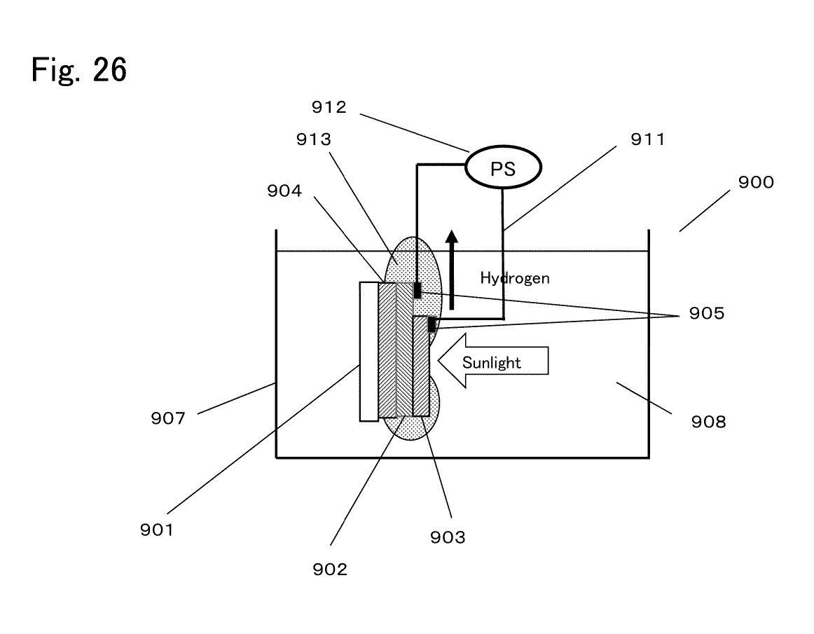

FIG. 26 is a schematic view illustrating a structure of a photocatalyst device 900 according to another embodiment, which uses, as a semiconductor electrode, a photocatalyst material having a structure in which p-GaN/GaCoN (thickness: 300 nm)/n-GaN (thickness: 250 nm) similar to the pan structure illustrated in FIG. 24 are laminated on a sapphire substrate 901. As the photocatalyst material GaCoN layer 902, a material having a composition containing 93.5% Ga and 6.5% Co is used. A water tank 907 is filled with 1 mol/L of a hydrochloric acid aqueous solution as an electrolyte aqueous solution 908, and unlike the eighth embodiment, only a semiconductor electrode is placed as an electrode. Further, charge extracting electrodes 905 are formed on junction surfaces of the GaCoN layer 902 and the n-GaN layer 903. The charge extracting electrodes 905 are coated with an epoxy resin as a waterproof insulating film 913 so as not to come into direct contact with the electrolyte aqueous solution 908. Numeral 912 denotes an external power source for applying a voltage between the charge extracting electrodes 905. A conductive wire 911 serves to electrically connect the charge extracting electrodes 905 to each other.

When the GaCoN layer 902 of FIG. 26 is irradiated with sunlight, electrons are excited. Holes h⁺ excited to the valence band of the GaCoN layer 902 move to the p-GaN layer 904, and electrons e⁻ excited to the conduction band of the GaCoN layer 902 move to the surface of the n-GaN layer 903. Then, the electrons e⁻ flow between the charge extracting electrodes 905 through the conductive wire 911. Even when a voltage was not applied to the charge extracting electrodes 905 by the external power source 912 under a state in which the GaCoN layer 902 was irradiated with sunlight, hydrogen was generated on the side of the n-GaN layer 903. Further, even when the GaCoN layer 902 was irradiated only with visible rays, generation of hydrogen on the side of the n-GaN layer 903 was similarly observed. This phenomenon shows that electrons are excited through the intermediate band by radiation of visible rays, as described above.

### Tenth Embodiment

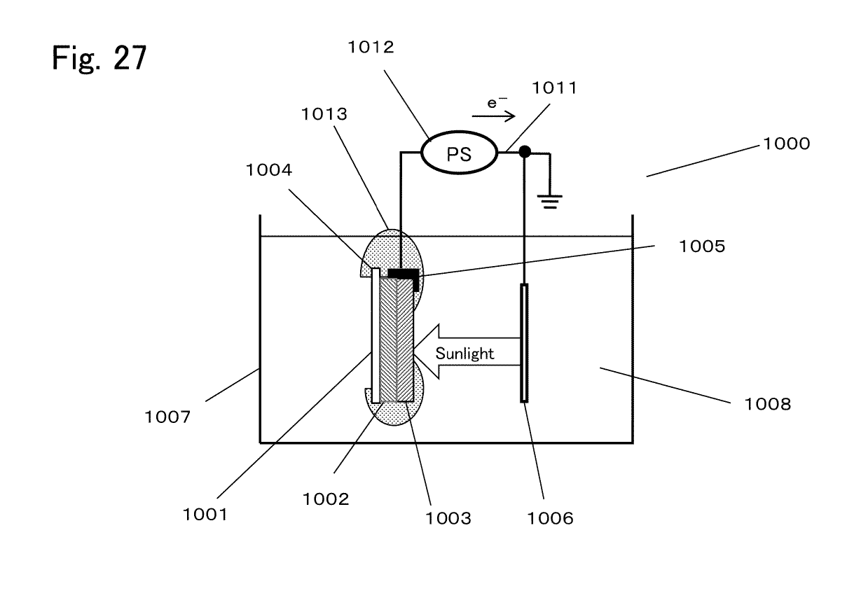

Next, a tenth embodiment using AlNiN as a photocatalyst material is described. FIG. 27 is a schematic view illustrating a structure of a photocatalyst device 1000 using a semiconductor electrode 1004 having a structure in which AlNiN 1002 and AlN 1003 are laminated in this order on a sapphire substrate 1001. As the photocatalyst material AlNiN 1002, a material having a composition containing 80% Al and 20% 3d-transition metal Ni is used. A water tank 1007 is filled with 1 mol/L of a hydrochloric acid aqueous solution as an electrolyte aqueous solution 1008, and a platinum electrode 1006 is placed together with the semiconductor electrode 1004 in the water tank 1007. A charge extracting electrode 1005 is formed on end faces of the AlNiN layer 1002 and the AlN layer 1003. The charge extracting electrode 1005 is coated with an epoxy resin as a waterproof insulating film 1013 so as not to come into direct contact with the electrolyte aqueous solution 1008. Numeral 1012 denotes an external power source for applying a voltage to the charge extracting electrode 1005. A conductive wire 1011 serves to electrically connect the charge extracting electrode 1005 to the platinum electrode 1006.

When the AlNiN layer 1002 was irradiated with sunlight, electrons were excited, and in the case where a voltage was not applied to the charge extracting electrode 1005 by the external power source 1012, generation of hydrogen was observed on the side of the AlN layer 1003 of the semiconductor electrode 1004. Further, even when the AlNiN layer 1002 was irradiated only with visible rays, generation of hydrogen was observed on the side of the AlN layer 1003 of the semiconductor electrode 1004. When a negative voltage was applied to the charge extracting electrode 1005 by the external power source 1012 under a state in which sunlight or visible rays were radiated, generation of hydrogen was observed on the side of the platinum electrode 1006. Further, when a positive voltage was applied to the charge extracting electrode 1005 by the external power source 1012, generation of hydrogen was observed on the side of the AlN layer 1003 of the semiconductor electrode 1004. The reason that the generation of hydrogen with visible rays is possible is as follows. In the AlN, the band gap is about 6.2 eV. Thus, electrons are not excited by radiation of visible rays. However, the AlNiN layer 1002 has an intermediate band. Thus, electrons are excited even by radiation of visible rays, and light in ultraviolet, visible, and infrared regions of sunlight can be used effectively for generating hydrogen.

### Eleventh Embodiment

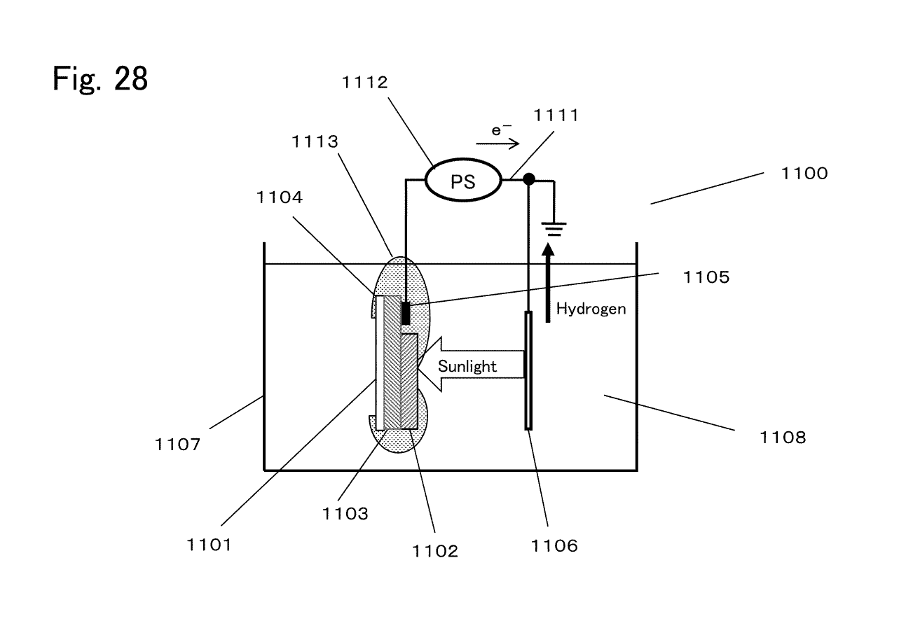

An eleventh embodiment using AlGaNiN as a photocatalyst material is described. FIG. 28 is a schematic view illustrating a structure of a photocatalyst device 1100 using a semiconductor electrode 1104 having a structure in which n-GaN 1103 and AlGaNiN 1102 are laminated in this order on a sapphire substrate 1101. As the photocatalyst material AlGaNiN 1002, a material having a composition containing 92% (AlGa), in which Al and Ga has a ratio of 10%:90%, and 8% 3d-transition metal Ni is used. A water tank 1107 is filled with 1 mol/L of a hydrochloric acid aqueous solution as an electrolyte aqueous solution 1108, and a platinum electrode 1106 is placed together with the semiconductor electrode 1104 in the water tank 1107. On the n-GaN layer 1103 formed on the sapphire substrate 1101, the AlGaNiN layer 1102 and the charge extracting electrode 1105 are formed. The charge extracting electrode 1105 is coated with an epoxy resin as a waterproof insulating film 1113 so as not to come into direct contact with the electrolyte aqueous solution 1108. Numeral 1112 denotes an external power source for applying a voltage to the charge extracting electrode 1105. A conductive wire 1111 serves to electrically connect the charge extracting electrode 1105 to the platinum electrode 1106.

When the AlGaNiN layer 1102 was irradiated with sunlight, electrons are excited, and in the case where a voltage was not applied to the charge extracting electrode 1105 by the external power source 1112, generation of hydrogen was observed on the side of the platinum electrode 1106. Further, even when the AlGaNiN layer 1102 was irradiated only with visible rays, generation of hydrogen was observed on the side of the platinum electrode 1106. When a negative voltage was applied to the charge extracting electrode 1105 by the external power source 1112 under a state in which sunlight and visible rays were radiated, generation of hydrogen was observed on the side of the platinum electrode 1106. When a positive voltage was applied to the charge extracting electrode 1105 by the external power source 1112 under a state in which sunlight and visible rays were radiated, generation of hydrogen was observed on the side of the AlGaNiN layer 1102 of the semiconductor electrode 1104. The reason that the generation of hydrogen even by radiation of only visible rays is possible is as follows. In the AlGaN (Al:Ga ratio of 10%:90%), which is the parent material of this embodiment, the band gap is about 3.7 eV. Thus, electrons are not excited by radiation of visible rays. However, the AlGaNiN layer 1102 has an intermediate band. Thus, electrons are excited even by radiation of visible rays, and sunlight can be used effectively for generating hydrogen.

### EXAMPLES

The photocatalyst material of the present invention is hereinafter described further in detail by way of examples. Note that, the present invention is not limited to the following examples.

### Example 1

### Production of Ga₁₋ₓMnₓN Film

A Ga₁₋ₓMnₓN film was produced using an MBE device. This device includes a vacuum tank, and, on the side of a bottom wall thereof, a gas introducing nozzle for introducing ammonia gas from a gas source, a first evaporation source, and a second evaporation source are arranged. On the side of a ceiling of the vacuum tank, a heater is arranged. In the first and second evaporation sources, a first metal material containing Ga as a main component and a second metal material containing Mn as a main component are arranged, respectively. Sapphire, silicon, quartz, or GaN can be used for a substrate, and in this example, a sapphire substrate was used.

The heater was energized to generate heat, and the sapphire substrate was heated to 950° C. to perform a cleaning process. After that, the temperature of the sapphire substrate was lowered to 550° C., and ammonia gas was ejected from the gas nozzle to be sprayed onto the sapphire substrate. At the same time, the first metal material in the first evaporation source was heated to generate a metal molecular beam containing Ga as a main component, and the surface of the sapphire substrate was irradiated with the metal molecular beam to form a buffer layer made of a GaN thin film.

After the buffer layer was formed to have a predetermined film thickness (0.2 μm), the sapphire substrate was increased in temperature to 720° C. Nitrogen atom-containing gas (ammonia gas in this case) was directly sprayed onto the surface of the buffer layer through the gas nozzle to perform thermal decomposition. At the same time, the first and second metal materials in the first and second evaporation sources were heated, and the buffer layer was irradiated with a molecular beam containing Ga as a main component and a molecular beam containing Mn as a main component to form a GaMnN film on the surface of the buffer layer. The GaMnN film with a thickness of 1 μm was formed under the conditions of the temperature of the first evaporation source at 850° C., the temperature of the second evaporation source at 630° C., and the flow rate of ammonia gas at 5 sccm.

After the GaMnN film was formed, the sapphire substrate was removed by, for example, chemical etching using a mixed acid of sulfuric acid and phosphoric acid or polishing to obtain the GaMnN film.

The Mn concentration of the resultant Ga₁₋ₓMnₓN film was measured by an Electron Probe Micro Analyzer (EPMA) to find that x was 0.082.

(Analysis of Crystal Structure)

An X-ray diffraction pattern of the GaMnN film produced by the MBE method was measured using a thin film X-ray diffractometer (X'pert manufactured by Philips Electronics Japan). A reflection peak was observed in the vicinity of 34.5° similarly to wurtzite-type GaN, and thus, it was found that the produced GaMnN film was of a wurtzite type.

(Measurement of Light Absorption Spectrum)

A light absorption spectrum was measured using an ultra-violet and visible spectrophotometers (UV-3600 and SOLID Spec-3700 manufactured by Shimadzu Corporation).

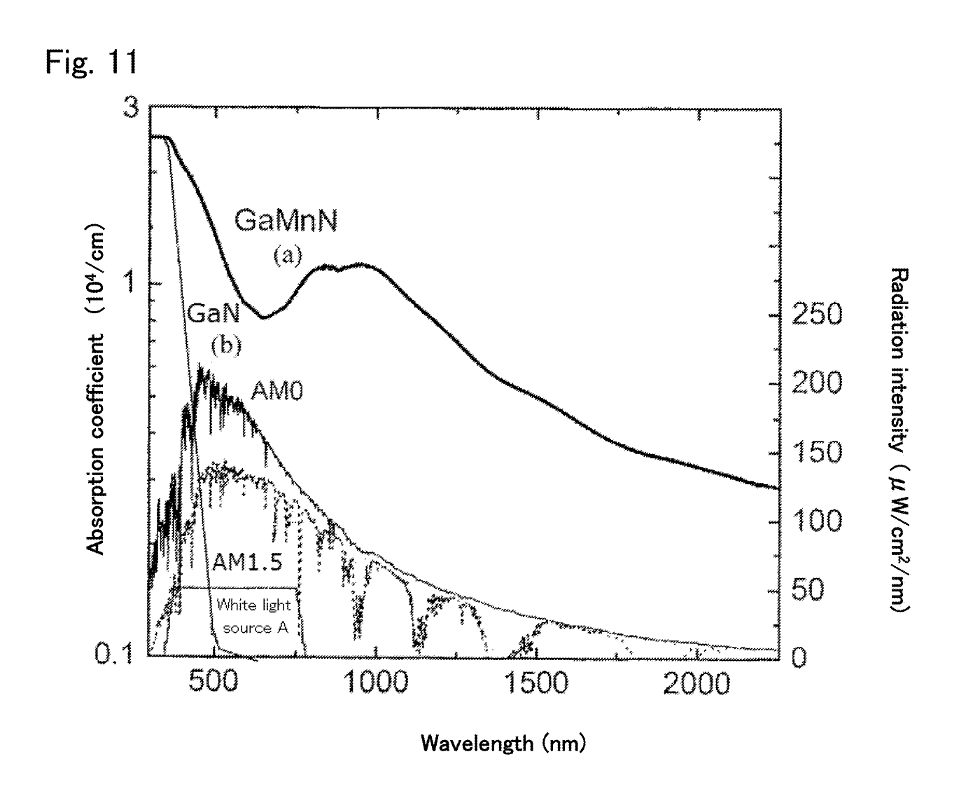

FIG. 11 shows an example of a light absorption spectrum of the resultant Ga₁₋ₓMnₓN film (x=0.082). Further, for your reference, FIG. 11 shows a radiation intensity spectrum of sunlight (AM0: on the orbit of the earth, AM1.5: the surface of the earth) and a radiation intensity spectrum of a white light source (MAX-302 manufactured by Asahi Spectra Co., Ltd.). GaN does not exhibit absorption in a wavelength region of 400 to 2,000 nm, whereas the Ga₁₋ₓMnₓN film has an absorption coefficient of 8,000 cm⁻¹ or more in a wavelength region of 400 to 1,000 nm. Further, the Ga₁₋ₓMnₓN film exhibits absorption more than GaN even in ultraviolet and infrared regions. Absorption by an impurity band is recognized in a broad peak structure in a region of 1,500 to 700 nm and a continuous absorption structure in a region of 700 to 400 nm. Further, as is apparent from FIG. 11, the light absorption spectrum of the Ga₁₋ₓMnₓN film substantially corresponds to the radiation intensity spectrum of sunlight in terms of wavelength region, and thus, unused light of sunlight can be used effectively.

### Example 2

### Production of Ga₁₋ₓMnₓN Film

A Ga₁₋ₓMnₓN film was produced by the same method as that of Example 1, except that an Mn supply amount was controlled by adjusting an Mn cell temperature during film formation. The film thickness was 0.4 μm, and x was 0.05. The light absorption coefficient was 1,000 cm⁻¹ or more in a wavelength region of 300 to 1,500 nm.

### Example 3

### Production of Ga_{1-x-z}MnₓMg_{z}N Film

A Ga_{1-x-z}MnₓMgₓN film was produced by the same method as that of Example 2, except that Mg was supplied simultaneously with Ga and Mn during production. The film thickness was 0.4 μm, x was 0.05, and z was 0.02. The light absorption coefficient was 1,000 cm⁻¹ or more in a wavelength region of 300 to 1,500 nm.

### Example 4

### Production of Ga₁₋ₓMnₓN:H_{y} Film

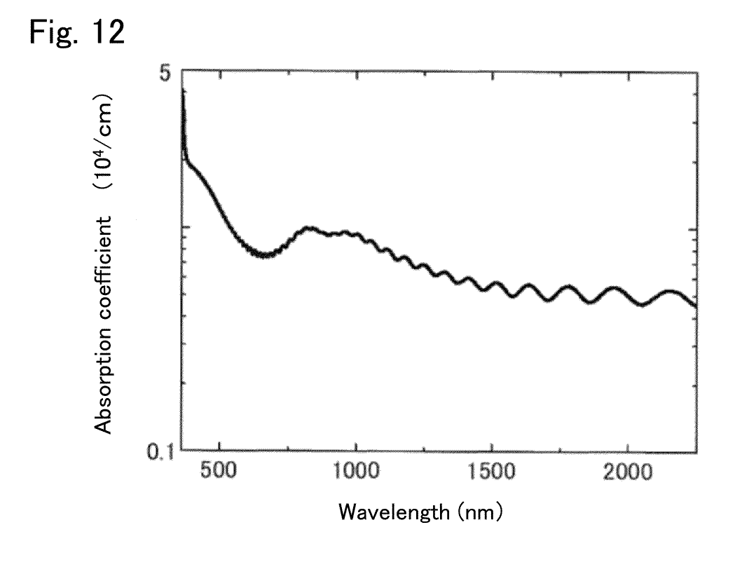

A Ga₁₋ₓMnₓN:H_{y} film was produced by the same method as that of Example 1, except that a substrate temperature was set at a low value of about 600° C. and decomposition of ammonia was suppressed partially to retain hydrogen during production of the Ga₁₋ₓMnₓN film. Further, regarding a Ga₁₋ₓMnₓN film which was produced at a high substrate temperature of 700° C. or higher and in which hydrogen did not remain, hydrogen molecules were thermally decomposed by a hot filament method in a hydrogen atmosphere and radiated to the Ga₁₋ₓMnₓN film to produce Ga₁₋ₓMnₓN:H_{y}. The film thickness was 0.3 μm, x was 0.06, and y was 0.03. FIG. 12 shows the light absorption spectrum. The Ga₁₋ₓMnₓN:H_{y} film had an absorption coefficient of 7,000 cm⁻¹ or more in a wavelength region of 400 to 1,000 nm, and an absorption coefficient of 1,000 cm⁻¹ or more in a wavelength region of 300 to 1,500 nm. Further, the Ga₁₋ₓMnₓN:H_{y} film exhibits absorption larger than that of GaN even in ultraviolet and infrared regions. The absorption caused by the impurity band was recognized in a broad peak structure in a region of 1,500 to 700 nm and a continuous absorption structure in a region of 700 to 400 nm. A film production example of a photocatalyst material by the MBE method and an example in which GaN was doped with a 3d-transition metal as characteristics of the photocatalyst material have been described. However, even when a film was produced by doping GaAlN and AlN with a 3d-transition metal, excellent light absorption characteristics are exhibited similarly. Thus, those materials can be also used as a photocatalyst material for a photocatalyst element of the present invention.

### Example 5

### Production by Sputtering

An example in which a GaN-based compound semiconductor was produced, for example, by sputtering is described. In a vacuum tank of a high-frequency sputtering device, p-GaN or n-GaN is placed on single crystal sapphire as a substrate, and a GaN target is placed so as to be opposed to the p-GaN or n-GaN. On the target, chips of a 3d-transition metal T to be replaced by Ga were set. An added amount of the 3d-transition metal T was adjusted by varying the number of chips in this case. On a rear surface of a holder on which the substrate is placed, a heater for heating the substrate is set. After the chamber was exhausted once, mixed gas of Ar—N₂ was introduced into the chamber. The substrate was heated to have a predetermined temperature, and thereafter, high-frequency power was applied so as to induce plasma, thereby performing sputtering film formation for a predetermined period of time. Further, prior to sputtering film formation, the substrate or the target may be cleaned in plasma.

Main sputtering film formation conditions are as follows.

RF power: 200 W

Substrate temperature: 300° C.

Ar:N₂ mixed ratio: 2:1

Film formation rate: 11 nm/min.

(Composition Analysis)

The resultant Ga₁₋ₓTₓN film was a film which was dense, flat and had less defects irrespective of the presence/absence of the addition of a 3d-transition metal. The composition of the GaN-based compound semiconductor film produced by sputtering was analyzed by Rutherford backscattering spectrometry, and x of Ga₁₋ₓTₓN was obtained. According to the analysis result, it was found from analysis amounts of Ga and the 3d-transition metal and an analysis amount of nitrogen that a thin film had a nonstoichiometric composition. Thus, part of the 3d-transition metal element may not have replaced the Ga position, however, the detail of which is under study.

(Results)

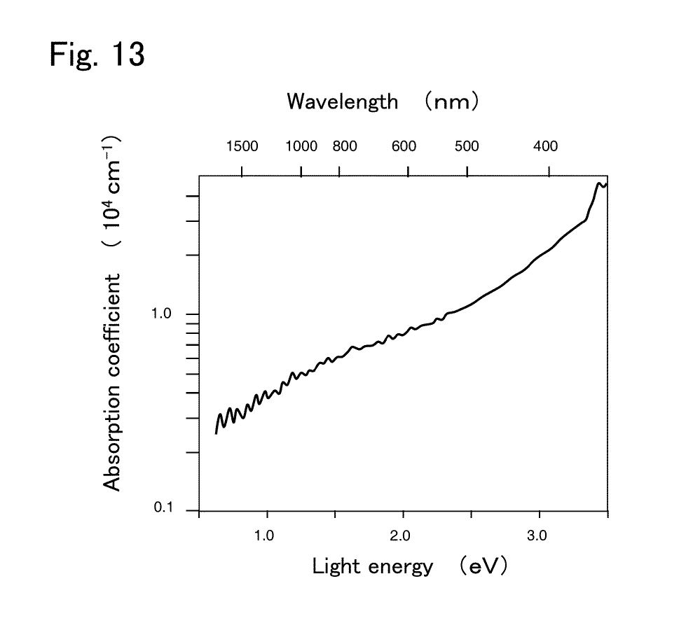

The light absorption spectrum of the thin film produced by sputtering was measured. For example, FIGS. 13 to 16 show examples of measurement results of light absorption spectra of samples in which Ga of GaN was replaced by various kinds of 3d-transition metals. FIG. 13 shows a light absorption spectrum of a sample in which a 3d-transition metal is V and x is 0.056. The light absorption spectrum has an absorption tail on a longer wavelength side from 3.3 eV and has a broad absorption peak in the vicinity of 1.5 eV. The absorption coefficient in a wavelength of 300 to 1,500 nm is 3,000 cm⁻¹ or more.

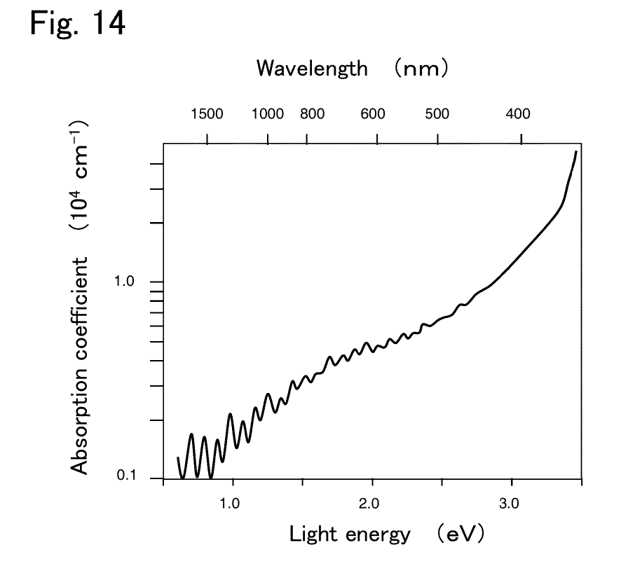

FIG. 14 shows a light absorption spectrum of a sample in which a 3d-transition metal is Cr and x is 0.088. The light absorption spectrum has an absorption tail on a longer wavelength side from 3.3 eV and has a broad absorption peak in the vicinity of 1.5 to 2.0 eV. The absorption coefficient in a wavelength of 300 to 1,500 nm is 1,000 cm⁻¹ or more.

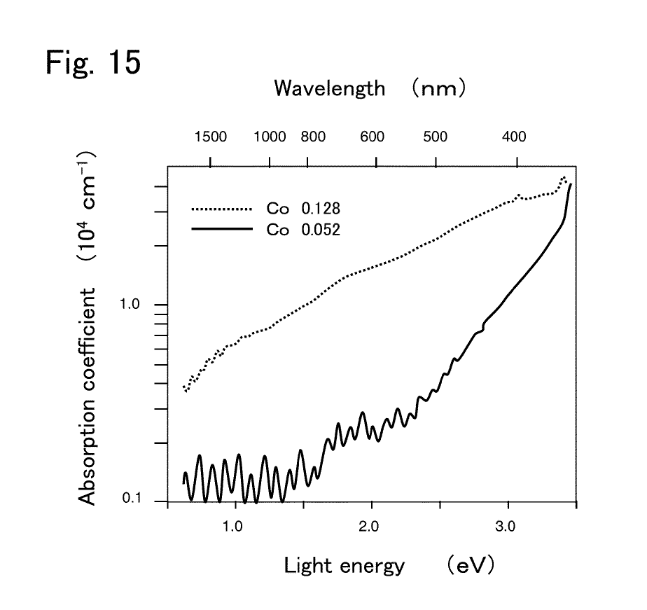

FIG. 15 shows light absorption spectra of samples in which a 3d-transition metal is Co. A sample in which x is 0.052 has an absorption tail on a longer wavelength side from 3.3 eV, and the absorption coefficient in a wavelength of 300 to 1,500 nm is 1,000 cm⁻¹ or more. Further, similarly, a sample in which x is 0.128 has a tail with a high absorption coefficient and a peak in the vicinity of 1.7 eV, and the absorption coefficient in a wavelength of 300 to 1,500 nm is 3,000 cm⁻¹ or more.

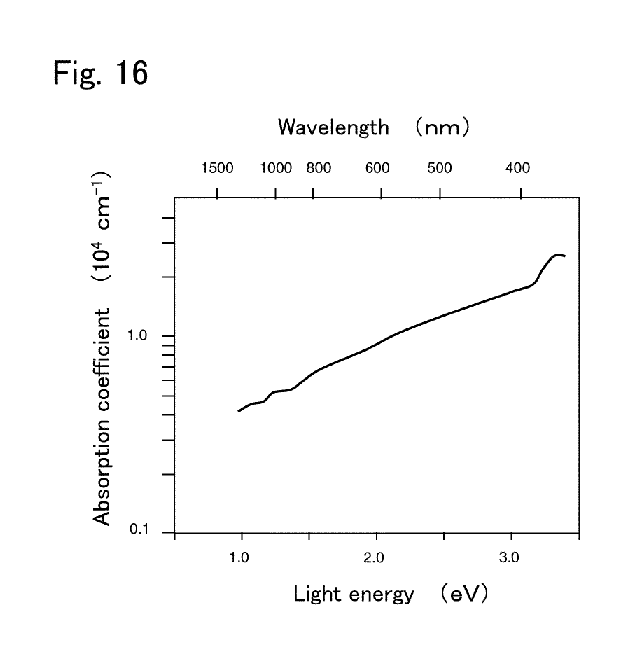

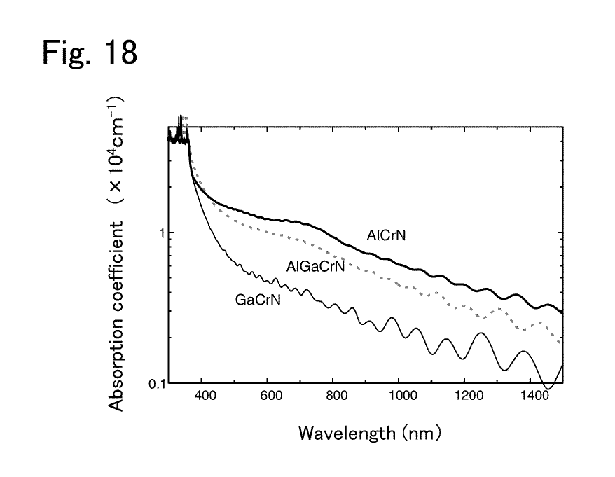

FIG. 16 shows a light absorption spectrum of a sample in which a 3d-transition metal is Mn and x is 0.2. The light absorption spectrum has a tail with a high absorption coefficient on a longer wavelength side from 3.3 eV and has an absorption coefficient in a wavelength of 300 to 1,500 nm is 5,000 cm⁻¹ or more. The sample produced by the MBE method had a clear absorption peak in the vicinity of 1.5 eV as shown in FIG. 18, whereas the sample produced by sputtering had a high absorption coefficient but no clear peak was observed therein. The reason for this has not been clarified. However, the reason is presumed as follows: the sample produced by the MBE method has relatively high crystallinity, and the sample produced by sputtering forms a plurality of energy levels in a band gap instead of forming a clear impurity band due to low crystallinity, which is under study.

### Example 6

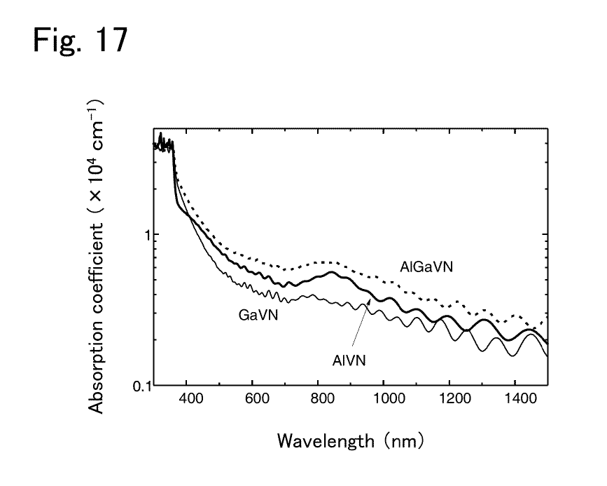

Next, a film production example of a photocatalyst material by sputtering is described. As characteristics thereof, even when films are formed by doping GaN, GaAlN, and AlN with 3d-transition metals T, excellent light absorption characteristics are similarly exhibited. The light absorption spectra of the thin films produced by sputtering were measured. FIGS. 17 to 21 show measurement results of light absorption spectra of samples in which Ga or Al of GaN, GaAlN, and AlN is replaced by various kinds of 3d-transition metals T. FIG. 17 shows light absorption spectra of samples in which parent materials are GaN, AlGaN, and AlN, a 3d-transition metal T is V, and x is 0.056. The light absorption spectra have an absorption tail on a longer wavelength side from 3.3 eV and have a broad absorption peak in the vicinity of 1.5 eV. The absorption coefficient in a wavelength of 300 to 1,500 nm is 3,000 cm⁻¹ or more.

FIG. 18 shows light absorption spectra of samples in which parent materials are GaN, AlGaN, and AlN, a 3d-transition metal is Cr, and x is 0.088. The light absorption spectra have an absorption tail on a longer wavelength side from 3.3 eV and have a broad absorption peak in the vicinity of 1.5 to 2.0 eV. The absorption coefficient in a wavelength of 300 to 1,500 nm is 1,000 cm⁻¹ or more.

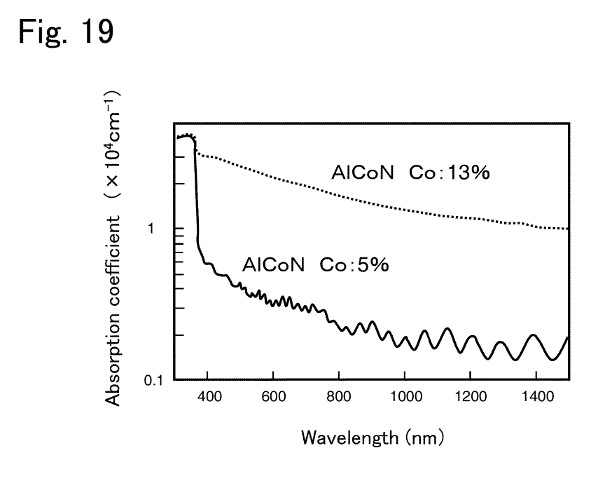

FIG. 19 shows light absorption spectra of samples in which a parent material is AlN and a 3d-transition metal is Co. A sample in which x is 0.052 has an absorption tail on a longer wavelength side from 370 nm, and the absorption coefficient in a wavelength of 300 to 1,500 nm is 1,000 cm⁻¹ or more. Further, similarly, a sample in which x is 0.13 has a tail with a high absorption coefficient and a peak in the vicinity of 730 nm, and the absorption coefficient in a wavelength of 300 to 1,500 nm is 3,000 cm⁻¹ or more.

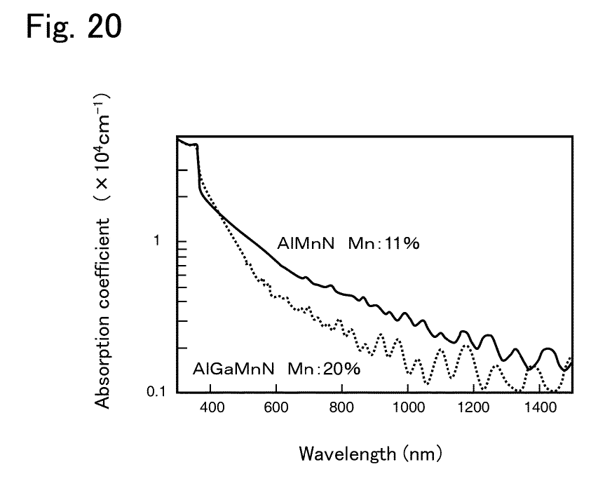

FIG. 20 shows light absorption spectra of samples in which parent materials are AlGaN and AlN, a 3d-transition metal is Mn, and x is 0.11 and 0.2. The light absorption spectra have a tail with a high absorption coefficient on a longer wavelength side from 370 nm and the absorption coefficient in a wavelength of 300 to 1,500 nm is 5,000 cm⁻¹ or more. The sample produced by the MBE method had a clear absorption peak in the vicinity of 1.5 eV as shown in FIG. 18, whereas the sample produced by sputtering had a high absorption coefficient but no clear peak was observed therein. The reason for this has not been clarified. However, the reason is presumed as follows but under study: the sample produced by the MBE method has relatively high crystallinity, while the sample produced by sputtering forms a plurality of energy levels in a band gap instead of forming a clear impurity band due to low crystallinity.

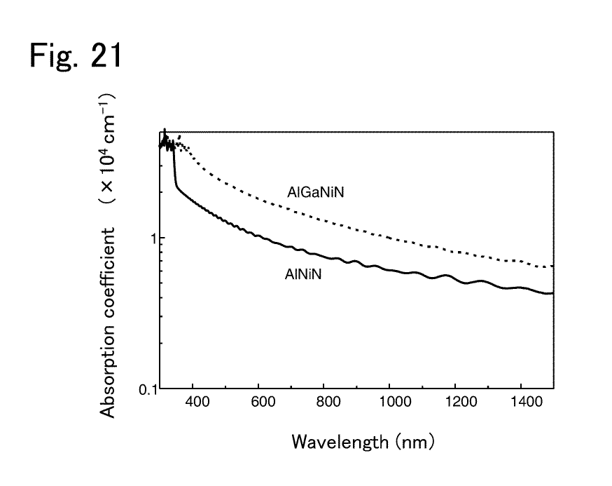

FIG. 21 shows light absorption spectra of samples in which parent materials are AlGaN and AlN, a 3d-transition metal is Ni, and x is 0.09. The light absorption spectra have a tail with a high absorption coefficient on a longer wavelength side from 370 nm and the absorption coefficient in a wavelength of 300 to 1,500 nm is 3,000 cm⁻¹ or more.

### INDUSTRIAL APPLICABILITY

The present invention uses a photocatalyst element formed using a photocatalyst material capable of absorbing a broad wavelength region of sunlight and converting the sunlight into electricity. Thus, the present invention can be used in a photocatalyst device which generates hydrogen directly from water or an aqueous solution.

### REFERENCE SIGNS LIST

100, 200, 300, 400, 500, 600, 700, 800, 900, 1000,
1100 photocatalyst device
101, 201, 401 anode
102, 202, 222, 302, 402, 422, 502 GaMnN layer
702, 802, 822, 902 GaCoN layer
1002 AlNiN
1003 AlN
203, 211, 202, 221, 303, 703, 804, 824, 924 p-GaN layer
401, 403, 421, 503, 803, 823, 903 n-GaN layer
601 n-GaMnN
602 p-GaMnN
701, 801, 901, 1001, 1101 sapphire substrate
704, 1004, 1104 semiconductor electrode
104, 204, 304, 404, 504, 705, 805, 905, 1005, 1105 charge extracting electrode
706, 806, 1006, 1106 platinum electrode
105, 205, 305, 405, 505, 605 ion exchange membrane
106, 206, 301, 406, 501 cathode
107, 207, 307, 407, 507, 607, 707, 807, 907, 1007, 1107 water tank
108, 208, 308, 408, 508, 608, 708, 808, 908, 1008, 1108 electrolyte aqueous solution
109, 209, 310, 409, 510, 609 anode chamber
110, 210, 309, 410, 509, 610 cathode chamber
111, 211, 311, 411, 511, 711, 811, 911, 1011, 1111 conductive wire
112, 212, 312, 412, 512, 713, 813, 913, 1013, 1113 waterproof insulating film
113, 213, 313, 413, 513 waterproof insulating tube
712, 812, 912, 1012, 1112 external power source

1. A photocatalyst device comprising:
a first semiconductor layer; and
a second semiconductor layer laminated on the first semiconductor layer, wherein
the first semiconductor layer is formed of a nitride-based compound semiconductor including a compound represented by a general formula (Al_{1-y}Ga_{y})₁₋ₓTₓN, part of Al and/or Ga in the compound is replaced by at least one kind of 3d-transition metals T, a replacement amount of the 3d-transition metal T is x, the at least one kind of 3d-transition metals T is at least one kind selected from the group consisting of Sc, Ti, V, Cr, Mn, Fe, Co, Ni, and Cu, wherein 0≦y≦1, wherein:
the nitride-based compound semiconductor has one or more impurity bands between a valence band and a conduction band; and
a light absorption coefficient of the nitride-based compound semiconductor has a value of 1,000 cm-1 or more in an entire wavelength region of 1,500 nm or less and 300 nm or more;
the second semiconductor layer is formed of
(i) a compound represented by a general formula (Al_{1-y}Ga_{y})₁₋ₓTₓN, part of Al and/or Ga in the compound being replaced by at least one kind of 3d-transition metals T, a replacement amount of a 3d-transition metal T being x, the at least one kind of 3d-transition metals T is at least one kind selected from the group consisting of Sc, Ti, V, Cr, Mn, Fe, Co, Ni, and Cu, wherein 0≦y≦1, wherein:
the nitride-based compound semiconductor has one or more impurity bands between a valence band and a conduction band; and
a light absorption coefficient of the nitride-based compound semiconductor has a value of 1,000 cm-1 or more in an entire wavelength region of 1,500 nm or less and 300 nm or more; or
(ii) a compound represented by a general formula Al₁₋ₘGaₘN (0≦m≦1, m may be the same as y).

2. The photocatalyst device according to claim 1, wherein 0.02≦x≦0.3.

3. The photocatalyst device according to claim 1, wherein the nitride-based compound semiconductor is doped with an acceptor dopant and/or a donor dopant.

4. The photocatalyst device according to claim 1, wherein the second semiconductor layer is formed of a compound represented by a general formula Al₁₋ₓGaₘN (0≦m≦1, m may be the same as y).

5. The photocatalyst device according to claim 4, wherein the first semiconductor layer and the second semiconductor layer form a pn junction.

6. The photocatalyst device according to claim 1, wherein the second semiconductor layer is the a compound represented by a general formula (Al_{1-y}Ga_{y})₁₋ₓTₓN, and the first semiconductor layer and the second semiconductor layer forms a pn junction.

7. The photocatalyst device according to claim 1, comprising a first layer, an intermediate layer, and a second layer which are laminated on one another, wherein:
the intermediate layer is the first semiconductor layer formed of the nitride-based compound semiconductor; and
the first layer and the second layer are the second semiconductor layers formed of compounds represented by a general formula Al₁₋ₙGaₙN (0≦n≦1, n may be the same as y).

8. The photocatalyst device according to claim 1, wherein when y=1, T is at least one kind selected from the group consisting of V, Cr, Co and N, and
when y=0, T is at least one kind selected from the group consisting of Sc, Ti, V, Cr, Fe, Co, Ni, and Cu.

9. The photocatalyst device according to claim 1, wherein 0<y<1.

10. The photocatalyst device according to claim 1, comprising a cathode and an anode connected to each other electrically,
wherein the first semiconductor layer or the second semiconductor layer is used for the cathode or the anode.
